(19) United States
(12) Patent Application Publication
(10) Pub. No.: US 2018/0365784 A1
(43) Pub. Date: Dec. 20, 2018

(54) METHODS AND SYSTEMS FOR DETECTION OF FAKED IDENTITY USING UNEXPECTED QUESTIONS AND COMPUTER INPUT DYNAMICS

(71) Applicant: Converus, Inc., Lehi, UT (US)

(72) Inventors: Giuseppe Sartori, Venezia (IT); Merylin Monaro, Venezia (IT)

(21) Appl. No.: 15/984,975

(22) Filed: May 21, 2018

Related U.S. Application Data
(60) Provisional application No. 62/508,907, filed on May 19, 2017.

(51) Int. Cl. G06Q 50/26; G06F 21/31

(52) U.S. Cl. CPC G06Q 50/26; G06F 21/316

(57) ABSTRACT

Methods, systems and point of use apparatus that utilize unexpected questions combined with the analysis of interactions with input devices may efficiently spot participants with faked identities without the need for any prior information on the examinee. While truth-tellers respond automatically to unexpected questions, liars have to “build” and verify their responses. This lack of automaticity is reflected in the interactions a user has with one or more computer input devices, such as keyboard or mouse, and the movements made when using that input device to provide the responses as well as in the number of errors made in those responses. By analyzing the interactions with the input devices and response errors on unexpected questions, systems and methods in accordance with the present disclosure are able to efficiently distinguish liars from truth-tellers. These systems and methods even allow for the identification of liars even when they are responding truthfully.

### CROSS-REFERENCE TO RELATED APPLICATION

This application claims the benefit of U.S. Provisional Application No. 62/508,907, filed May 19, 2017, the disclosure of which is incorporated herein by reference in its entirety.

### TECHNICAL FIELD

The present disclosure relates to the detection of faked identities and lie detection.

### BACKGROUND

The detection of faked identities is a major problem in security. The use of faked identities is a very common issue. People can fake their personal information for a number of reasons. Faked autobiographical information is, for example, observed in sports, with players claiming to be younger than what they really are. Social networks are plagued by faked profiles. Faked personal identity is also a major issue in security. In fact, a large number of terrorists are believed to be hidden among migrants from the Middle East entering Europe. Usually, migrants lack documents and their identity information is often based on self-declaration. Among migrants, it is believed that a high number of terrorists are giving false identities when entering borders. For example, one of the terrorists involved in the Brussels airport suicide bombing on Mar. 22, 2016 was using the identity of a former Inter Milan football player. In these cases, biometric identification tools (e.g., fingerprints) could not be applied as most of the suspects were previously unknown. Interestingly, detection techniques could be, in principle, applied.

False identities in online services represent another unresolved issue. They expose people to the risk of being attacked and manipulated. Existing security systems for online authentication are now primarily based on passwords, while other biometric methods have been recently proposed. These are based on human-computer interaction recording, such as systems for user authentication and identification via keystroke analysis or mouse dynamics. In short, machines are trained to recognize the typical usage pattern of the keyboard/mouse of a specific user. However, these methods entail acquiring the writing or the mouse movement pattern of each user and storing it in a database queried upon every authentication.

From the beginning, starting with the pioneer work of Benussi, the identification of deceptive responses has mainly been based on the use of physiological measures. More recently, reaction time (RT)-based techniques have been introduced. These are based on the response latencies to the presented stimulus of interest. There is wide consensus regarding the fact that deception is cognitively more complex than truth-telling and that this higher cognitive complexity is reflected in a number of indices of cognitive effort, including, for example, reaction times. There is evidence that the process of inhibiting the truthful response, which is automatically activated, and substituting it with a deceptive response may be a complex cognitive task. However, in some instances, responding with a lie may be faster than truthfully responding. In fact, distinct types of lies may differ in their cognitive complexity and may require different levels of cognitive effort. For example, the cognitive effort may be minimal when the subject is simply denying a fact that actually happened.

By contrast, it could be very high when fabricating complex lies, such as when Ulysses, the hero of The Odyssey, told Polypheme that his real name was “No-man.” This lie was intended to fool Polypheme but was also supposed to be easily spotted as a lie by Polypheme's one-eyed companions.

RT-based memory detection has a number of advantages over alternative psychophysiological techniques, especially when a high number of subjects are under scrutiny. First, RTs are less sensitive to strong individual or environmental changes, such as in the case of physiological parameters. Secondly, this technique has the unparalleled feature that it may be applied using merely a computer and administered to a large number of examinees over the Web. Currently, two memory-detection techniques based on RTs that are used to present words or sentences may be adapted as tools for identity verification. The Concealed Information Test (CIT-RT) and the autobiographical Implicit Association Test (aIAT) are RT-based techniques that have undergone extensive scrutiny with satisfactory results.

The CIT-RT is a technique that consists of presenting the critical information within a series of very similar, noncritical sources of distractor information. For example, if the concealed knowledge about a murder weapon is under scrutiny, a knife (the known murder weapon) will be presented together with distractors that are also potential murder weapons (e.g., a gun, etc.). For the innocent subjects, the response is expected to be similar to all stimuli. By contrast, for the guilty subject (with guilty knowledge for the weapon), longer responses for the critical item are expected (e.g., the knife). When applied to verify whether the autobiographical information that the examinee claims corresponds to the true identity, the CIT efficiently succeeds in distinguishing the identities of liars and truth-tellers.

The aIAT is a memory-detection methodology that exploits consistency/inconsistency between sentences. It includes stimuli belonging to four categories: two of them are logical categories represented by sentences that are certainly true (e.g., “I am in front of a computer”) or certainly false (e.g., “I am climbing a mountain”) for the respondent and related to the moment of testing. The other two categories are represented by alternative versions of the autobiographical memory under investigation (e.g., “I went to Paris for Christmas” vs. “I went to London for Christmas”), with only one of the two being true. During the test, the examined subject performs a categorization task. The true autobiographical event is identified because it determines faster RTs when sharing the same motor response with certainly true sentences.

With regard to the average classification accuracy of RT-based lie-detection techniques, CIT and aIAT have similar reported accuracies (around 90%). Nevertheless, the aIAT and CIT suffer from an important limitation: both of them require the true-identity information to be included in the test. The CIT-RT contrasts information about the true identity with information about the faked identity. The aIAT is also built in such a way that, of the two contrasted memories, one should be true and one should be false. If we build an aIAT only with the claimed (faked) identity, we will have two memories that are both false, and the test will not satisfy one of the basic constraints in the application of the procedure. This limitation of the available techniques is therefore a major issue for applications in real contexts, even if Meixer and Rosenfeld carried out a step in this direction. In fact, in most investigative settings, the subject's true identity is completely unknown to the examiner, who is interested in evaluating whether the claimed identity is true or not.

Thus, current memory-detection techniques cannot be used in many contexts as they require prior knowledge of the respondent's true identity. For example, they are not suitable for use as a general screening tool at a point of entry. A system or method that was able to identify participants with faked identities without the need for any prior information on the examinee would be an improvement in the art.

### SUMMARY

The present disclosure is directed to novel techniques, systems and apparatus for detecting faked identities based on the use of unexpected questions that may be used to check the respondent identity without any prior autobiographical information. While truth-tellers respond automatically to unexpected questions, liars have to “build” and verify their responses. This lack of automaticity is reflected in the interactions a user has with one or more computer input devices, such as keyboard or mouse, and the movements made when using that input device to provide the responses as well as in the number of errors made in those responses. By analyzing the interactions with the input devices and response errors on unexpected questions, systems and methods in accordance with the present disclosure are able to efficiently distinguish liars from truth-tellers. These systems and methods even allow for the identification of liars even when they are responding truthfully. Methods, systems and point of use apparatus that utilize unexpected questions combined with the analysis of interactions with input devices may efficiently spot participants with faked identities without the need for any prior information on the examinee.

In some embodiments, the input devices may include a computer mouse which is analyzed for movement parameters, including velocity, acceleration, and trajectory. In others they may include keyboards which are analyzed for movement parameters.

In some embodiments, the present disclosure thus provides the ability to be used where currently available techniques cannot be used when critical information is evaluated for veracity is not available. For example, where the real identity of the respondent who is trying to hide his identity is not available. Thus, the present disclosure presents a new paradigm that may be used to identify whether personal information is true. Most importantly, we will show that a faked identity can be spotted in the absence of any information about the suspect's true identity. Faked identities will be detected using unexpected questions combined with an analysis of a responder's interactions with computer input devices.

### FIGURES

FIG. 1 is a graphic representation of average mouse movement trajectories for liars and truth-tellers for responses to expected and unexpected questions.

FIG. 2A is a graphic representation of prototypical mouse movement trajectories for a truth-teller responding to a control question.

FIG. 2B is a graphic representation of prototypical mouse movement trajectories for a truth-teller responding to an unexpected question.

FIG. 3A is a graphic representation of prototypical mouse movement trajectories for a liar responding to a control question.

FIG. 3B is a graphic representation of prototypical mouse movement trajectories for a liar responding to an unexpected question.

FIGS. 4A, 4B and 4C are graphic representations of mouse movement trajectories for liars and truth-tellers for responses to control, expected and unexpected questions.

FIG. 5 is a graphic representation of mouse movement trajectories for responses to YES and NO questions.

FIG. 6 is a graphic representation of average mouse movement trajectories for liars and truth-tellers for responses where both respond truthfully.

### DETAILED DESCRIPTION

It will be appreciated by those skilled in the art that the embodiments herein described, while illustrative, are not intended to so limit this disclosure or the scope of the appended claims. Those skilled in the art will also understand that various combinations or modifications of the embodiments presented herein can be made without departing from the scope of this disclosure. All such alternate embodiments are within the scope of the present disclosure.

The present disclosure is directed to novel techniques for detecting faked identities based on the use of unexpected questions that may be used to check the respondent identity without any prior autobiographical information. While truth-tellers respond automatically to unexpected questions, liars have to “build” and verify their responses. This lack of automaticity is reflected in the interactions a user has with one or more computer input devices, such as keyboard or mouse, and the movements made when using that input device to provide the responses as well as in the number of errors made in those responses. By analyzing the interactions with the input devices and response errors on unexpected questions, systems and methods in accordance with the present disclosure are able to efficiently distinguish liars from truth-tellers. These systems and methods even allow for the identification of liars even when they are responding truthfully. Methods, systems and point of use apparatus that utilize unexpected questions combined with the analysis of interactions with input devices may efficiently spot participants with faked identities without the need for any prior information on the examinee.

In some embodiments, the input devices may include a computer mouse which is analyzed for movement parameters, including velocity, acceleration, and trajectory. In others they may include keyboards which are analyzed for movement parameters. Other additional embodiments may include other input devices where the movements of the responding users can be tracked and analyzed. In practice it has been found that a digital keyboard on a mobile device may be used in the place of a physical keyboard with movement parameters measured on the interactions of a user with the displayed buttons. Similarly, swipe gestures on a mobile device touchscreen display may be tracked and analyzed in a comparable manner to mouse movements and “taps” made on such a display may be tracked and analyzed similar to mouse click. This allows the techniques and systems in accordance with the present disclosure to be expanded to mobile platforms.

In some embodiments, the present disclosure thus provides the ability to be used where currently available techniques cannot be used when critical information is evaluated for veracity is not available. For example, where the real identity of the respondent who is trying to hide his identity is not available. Thus, the present disclosure presents a new paradigm that may be used to identify whether personal information is true. Most importantly, we will show that a faked identity can be spotted in the absence of any information about the suspect's true identity. Faked identities will be detected using unexpected questions combined with an analysis of a responder's interactions with computer input devices.

Overt lie detection includes all techniques for which the examinee knowingly takes a lie-detection test. This category includes the polygraph, P300, fMRI, CIT, aIAT and others. Covert lie detection refers to conditions under which the examinee is unaware that he or she is under the scrutiny of a scientifically based lie-detection technique. Such covert lie-detection techniques have included thermal imaging lie detection, voice stress analysis, and linguistic analysis. Embodiments in accordance with the present disclosure may be used for overt lie detection but may be especially suited for use in covert lie-detection. For example, systems and methods in accordance with the present disclosure could be integrated into a data input system at a border crossing that is used by individuals passing through customs, or in a system used by a financial institution for collecting data from customers. In such settings, no hint need be given to a subject that he or she is under the scrutiny of a credibility-assessment technique.

### Example 1—Detection of Faked Identity Using Unexpected Questions and Mouse Dynamics

In a first set of experiments, it was shown that a faked identity can be spotted in the absence of any information about the suspect's true identity. Faked identities were detected using unexpected questions combined with an analysis of mouse movements during the response in a binary classification task. In the experiments presented here, the participants do not respond by pressing YES/NO buttons using the keyboard, as in the RT-CIT or aIAT, but they are instead required to respond by clicking with a mouse virtual buttons appearing on the computer screen along with questions regarding their identities. The use of a mouse for recording responses has a number of advantages over the use of a keyboard. While the press of a button may permit only RTs to be recorded, mouse recording allows several indicators to be collected, including but not limited to RT (e.g., velocity, acceleration, and trajectory). The technique is also promising regarding resistance to countermeasures, as a high number of movement parameters seems, in principle, more difficult to control entirely via efficient, planned countermeasures to lie detection.

It has been shown that the analysis of mouse trajectories can capture cognitive complexity in stimulus processing when participants are required to deliver multiple-choice responses. This procedure has been applied to a large number of fields and has proved useful in highlighting cognitive complexity related to negative sentence verification, racial attitudes, perceptions, prospective memory, and lexical decisions. Duran et al. presented a pioneering investigation on lie detection. The authors recorded motor trajectories (the authors did not use a mouse to record the responses but rather a Nintendo Wii controller) while the subjects were engaged in an instructed lying task. During the task, the participants were required to respond truthfully or with lies to the presented sentences, as indexed by a visual cue. The analysis of motor trajectories led to interesting results. Instructed lies could be distinguished from truthful responses on several parameters, including the motor onset time, the overall time required for responding, the trajectory of the movement, and kinematic parameters, such as velocity and acceleration. Their experiment highlighted the fact that cognitive conflict induced by a lie affected the response trajectory but did not show directly its efficiency in classifying deceptive subjects from truth-tellers. In short, the technique that the authors investigated can be used to identify when a truth-teller lies but not when a liar lies, as their procedure compares, within the same truth-telling subject, truthful responses with lying responses.

In the present disclosure, the trajectories of motor responses using the mouse were investigated while the participants were tested on questions regarding their identities. Two types of questions were asked: expected questions and unexpected questions. Vrij and co-workers pioneered the use of unexpected questions, and there is growing experimental support for the notion that, during investigative interviewing, deceptive subjects will be uncovered more easily using unexpected questions versus expected questions. It has been shown that liars plan for possible interviews by rehearsing the questions they expect to be asked as well. Liars give their planned responses to expected questions easily and quickly, but they need to fabricate plausible responses in the case of unexpected questions, and this yields an increase in the cognitive load. By contrast, truthful responses are not plagued by the side effects of the cognitive load as they are quite automatic and effortless for both expected and unexpected questions. Using the methodology of unexpected questions in investigative interviewing, Lancaster et al. reported good classification rates for both truth-tellers (78%) and liars (83%). Lancaster et al. results were observed by comparing the difference in the number of details reported when responding to expected and unexpected questions. In short, liars, with respect to truth-tellers, report many more details to the expected questions versus the unexpected questions, and lie detection can capitalize on this difference.

The experiment reported here consists of a binary classification task involving expected and unexpected questions about identity. Expected questions covered typical information as reported in documents, while unexpected questions covered information that was well known and automatically retrieved by the truth-teller but that should be “computed-on-the-spot” by liars. An example of an expected question would be one's date of birth, and a corresponding unexpected question would be the zodiac corresponding to the date of birth. While truth-tellers easily verify questions involving the zodiac, liars do not have the zodiac immediately available, and they have to compute it for a correct verification. The uncertainty in responding to unexpected questions may lead to errors. Furthermore, it was found that the trajectory mouse response, analyzed using kinematic parameters and other spatial and temporal parameters intended to capture the uncertainty in motor response, could be useful in detecting deception. Deception, therefore, is expected to reflect itself in the form of the trajectories.

### Methods

In an identity verification task, the liars are typically required to learn the autobiographical information of a new identity and to take the test responding as if that information were real for them. For example, Verschuere et al. asked subjects to adopt a false identity and rehearse and recall it until their performance was errorless. Then, the liars were required to respond as if their new identity was the true one. Similarly, here we required the deceptive participants to learn a new identity. During the testing session, the participants were presented both expected and unexpected questions about their personal information. The expected questions included information about the false identity that was assigned to liars and rehearsed before the test until the subjects did not make any errors. The truth-tellers rehearsed their true identities. The expected questions were on the typical information reported on an identification (ID) card (e.g., name, surname, date of birth, place of birth). By contrast, the unexpected questions were identity-related questions to which the subjects were not prepared to respond. These unexpected questions were directly derived from the expected questions (e.g., the identity's age and zodiac sign are derived from the date of birth; while questions about the date of birth are expected, questions about age and zodiac sign are unexpected). For example, if the subject was rehearsing the year of birth as it appeared on a fake ID card (e.g., 1988), a birth-related unexpected question was about the age (e.g., 38).

For a truthful responder, unexpected questions are supposed to elicit the correct response automatically. By contrast, an identity liar has to reconstruct the non-rehearsed unexpected information and verify it. Therefore, this process takes time before the response is emitted, which is reflected in longer RTs. In short, “Unexpected questions will increase a liar's cognitive load” and this is expected to reflect itself not only in the RT and in the number of errors but also in the mouse trajectories.

In the following, we will describe in detail the experiment structure and the measures collected. The ethics committee for psychological research of the University of Padova approved the experimental procedure.

Forty Italian-speaking participants were recruited at the Department of Psychology of Padova University. The sample consisted of 17 males and 23 females. Their average age was 25 years (SD=4.6), and their average education level was 17 years (SD=1.8). All of the participants were right handed. These first 40 participants were used to develop the model that was later tested, for generalization, in a fresh new group of 20 Italian-speaking participants (10 liars and 10 truth-tellers). This second sample consisted of 9 males and 11 females. Their average age was 23 years (SD=1.5), and their average education level was 17 years (SD=0.83). Both groups of subjects provided informed consent before the experiment.

Thirty-two sentences displayed in the upper part of the computer screen were presented to all of the participants. The squares representing the YES and NO responses were located in the upper left and upper right of the computer screen. Sixteen sentences required a YES response, and 16 required a NO response, for both the liars and the truth-tellers. The 32 experimental questions were preceded by 6 training questions (3 requiring a YES response and 3 requiring a NO response) on issues related to the identity not included in the experiment proper (e.g., “Is your weight 51 kg?”). Sentences that required a YES response belonged to the following categories:

Expected Questions:

These included information that was rehearsed before the experiment, both for the truth-tellers and for the liars. The liars responded with personal information about fake identity profiles that the experimenter had assigned to them. The truth-tellers responded to questions regarding their true identities.

Unexpected Questions:

The unexpected questions included information closely related to the false identities but not explicitly rehearsed before the experiment by either the truth-tellers or the liars. In this case, the liars responded to information related to the fake identities assigned to them, while the truth-tellers responded to the questions regarding their true identities.

Control Questions:

Control questions were intermixed with the expected and unexpected questions. The control questions (n=8; 4 requiring a YES response and 4 a NO response) included personal information to which the subjects had to respond truthfully because they could not be hidden to the examiner supervising the test. For example, “Are you male?” (for a male subject) required a YES response, whereas “Are you a female?” (for a male subject) required a NO response. Therefore, the control questions required truthful responses by both the liars and truth-tellers, even if they were related to identity.

Table 1 reports examples of expected questions, unexpected questions and control questions related to truth or fake identity.

TABLE 1

| | | |
|---|---|---|
| | Profile that requires YES | Profile that requires NO |
| | response by both liars | response by both liars |
| Topic | and truth-tellers | and truth-tellers |

Expected questions

| | | |
|---|---|---|
| Name | Is Giulia your name? | Is Caterina your name? |
| Surname | Is Rossi your last name? | Is Moretti your last name? |
| Year of birth | Were you born in 1995? | Were you born in 1991? |
| Month of birth | Were you born in | Were you born in April? |
| | January? | |
| Town of | Do you live in Padova? | Do you live in Pisa? |
| residence | | |
| Street of | Do you live in via dei | Do you live in via Piave |
| residence | Colli 9? | 25? |

Unexpected questions

| | | |
|---|---|---|
| Age | Are you 21 years old? | Are you 25 years old? |
| Zodiac sign | Is Capricorn your zodiac | Is Aries your zodiac sign? |
| | sign? | |
| Region of birth | Were you born in | Were you born in |
| | Lombardia? | Campania? |
| Province of birth | Were you born in the | Were you born in the |
| | province of Milano? | province of Napoli? |
| Region of | Do you live in Veneto? | Do you live in Toscana? |
| residence | | |
| Capital town of | Is Venezia the capital | Is Firenze the capital |
| the region of | of the region where | of the region where |
| residence | you live? | you live? |

Control questions

| | | |
|---|---|---|
| Gender | Are you female? | Are you male? |
| Skin color | Is your skin white? | Is your skin brown? |
| Hair color | Do you have blond hair? | Do you have black hair? |
| Citizenship | Are you Italian? | Are you French? |

For both the liars and the truth-tellers, half of the expected, unexpected, and control questions (n=16) required YES responses. By contrast, 16 questions derived from the expected, unexpected, and control questions required NO responses as displayed in Table 1.

As can be seen in Table 2, the responses of the liars and truth-tellers differed only in the expected and unexpected YES responses. In fact, for the liars, the expected and unexpected questions regarding their faked identities were actually NO responses that, because they were lying, required YES responses. In other words, only the questions with expected and unexpected YES responses differentiated the two groups because the truth-tellers responded sincerely, while the liars cheated. For all of the other questions (control YES, control NO, expected NO, unexpected NO), both the liars and truth-tellers responded truthfully.

TABLE 2
Examples of expected, unexpected and control questions that require a YES or a NO response.

| Sentence Type | Question for liars | Question for truth-tellers |
|---|---|---|
| Expected YES (e.g., Town of residence) | Do you live in Padova? | Do you live in Padova? |
| Unexpected YES (e.g., Region of residence) | Do you live in Veneto? | Do you live in Veneto? |
| Control YES (e.g., Citizenship) | Are you Italian? | Are you Italian? |
| Expected NO (e.g., Town of residence) | Do you live in Firenze? | Do you live in Firenze? |
| Unexpected NO (e.g. Region of residence) | Do you live in Toscana? | Do you live in Toscana? |
| Control NO (e.g., Citizenship) | Are you French? | Are you French? |

The table reports examples of expected questions, unexpected questions and control questions that require a YES or a NO response.

The experiment was carried out using Mouse Tracker software, which was disclosed in Freeman J B, Ambady N. Mousetracker: Software for studying real-time mental processing using a computer mouse-tracking method. Behavior Research Methods. 2010; 42:226-241, which is incorporated by reference herein in its entirety. Twenty participants answered truthfully, while the others were instructed to lie about their identities according to a false profile that was over-learned before starting the experiment, according to Verschuere et al. The 20 liars were instructed to learn a false identity from a faked Italian identity card, to which a photo of the subject was attached and that also reported false personal data. After the learning phase, the participants recalled the information they read on the ID card twice. Between the two recalls, they were required to perform some mental arithmetic as a distracting task. On the other hand, the truth-tellers also performed mental arithmetic and revisited their real autobiographical data only once before starting the experiment. During the experimental task, the 6 expected questions, 6 unexpected questions, and 4 control questions described above were presented randomly intermixed. For each of the 16 questions that required a YES response, a similar question requiring a NO response was presented. Each participant responded to 32 questions plus 6 training questions that were not included in the analysis. Half of the time, the YES question appeared first, and during the other half, it appeared second. The participants initiated the presentation of each question by pressing a START button, which appeared in the center of the lower part of the computer screen. The response was given by pressing one of two response buttons appearing in the upper part of the computer screen, one in the upper-left corner and one in the upper-right corner.

For each response, the Mouse Tracker software recorded the mouse position from the starting point to the press of the button. Because the recorded trajectories had different lengths, each motor response was time normalized to permit the trials to be averaged and compared. Using linear interpolation, the software calculated time normalization in 101 time frames. As a result, each trajectory had 101 time frames, and each time frame had corresponding X and Y coordinates. We identified the moment in time in which the two groups showed a maximum difference during the movement along the y-axis. These points of maximum difference in time were coded as Y18, Y29, and Y30 (the total time was preliminarily rescaled to 100 time frames according to the procedure that Freeman and Ambady validated). Then, we calculated the velocity and acceleration in these time frames. Mouse Tracker software recorded by default also other spatial and temporal parameters. Here we report all the parameters preliminarily collected by the Mouse Tracker software and used to encode the mouse trajectory. The parameters collected from the motor responses to each of the questions were the following:

Number of errors: the total number of errors in responding to the 32 questions.

Initiation time (IT): the time between the appearance of the question and the beginning of the mouse movement.

Reaction time (RT): the time between the appearance of the question and the virtual button pressing performed with the mouse.

Maximum deviation (MD): the maximum perpendicular distance between the actual trajectory and the ideal trajectory (the line connecting the starting button with the expected response button.

Area under the curve (AUC): the geometric area included between the actual trajectory and the ideal trajectory.

Maximum deviation time (MD-time): the time taken to reach the point of maximum deviation from the ideal trajectory.

x-flip: The total number of changes in directions of the mouse during the full trajectory on x-axis.

y-flip: The total number of changes in directions of the mouse during the full trajectory on y-axis.

X, Y coordinates over time (Xn, Yn): the position of the mouse along the axis over time.

Velocity over time: the velocity of the mouse between two time frames.

Acceleration over time: the acceleration of the mouse movement between two time frames.

The final list of candidate predictors included 13 variables, which mapped the various dimensions of the response: number of errors, Initiation Time (IT), Reaction Time (RT), Maximum Deviation (MD), Area Under the Curve (AUC), Maximum Deviation time (MD-time), x-flip, y-flip, Y30, Y29, Y18, Y30±Y29, and Y29±Y18. For each of the variables we computed the average value of the 32 responses for each participant.

A correlation analysis was conducted to highlight the independent variables that had the maximum correlation with the dependent variable (truth-tellers vs. liars) and minimum correlation across the independent variables. For each feature, the mean value of all of the responses (both YES and NO responses) within each subject was considered. The total of 13 independent variables were entered into the correlation analysis. The following features were selected on the basis of these criteria and later used as predictors to develop the machine learning (ML) classifiers: number of errors (rpb=0.68), AUC (rpb=0.53), MD-time (rpb=0.45), and Y29 (rpb=0.42) (rpb is the value of the correlation between the dependent and independent variables).

### Analysis and Results

In this section, the steps followed to analyze the data and the procedure used in developing the ML classifiers are reported.

### Analysis of Trajectories

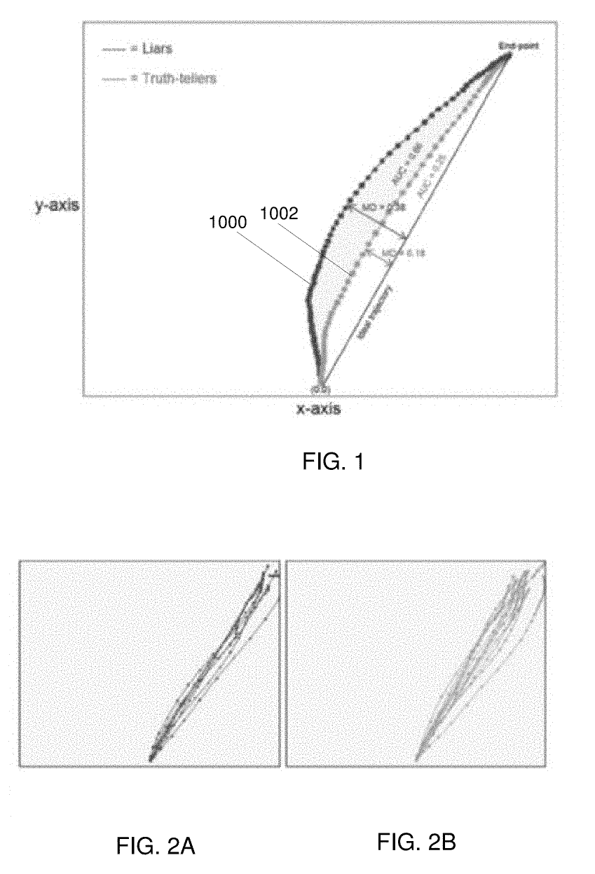

The first analysis compared the responses of liars and truth-tellers by averaging across individual responses to both YES and NO responses. FIG. 1 depicts the average trajectory for liars at 1000 and the average trajectory for truth-tellers at 1002 responding YES to the expected and unexpected questions (the only questions to which the liars responded deceitfully) are represented. As can be noticed, the two experimental groups differed in both the AUC (0.66 vs 0.25) and MD (0.38 vs 0.18) parameters. The truth-tellers' responses resulted in a more direct trajectory connecting the starting point with the correct response. By contrast, the liars initially deviated toward their default correct response and later changed their trajectory to press the false response button. Furthermore, liars spent more time moving on the y-axis in the initial phase of the response than the truth-tellers. The maximum difference between the two groups in mouse position along the y-axis was detected at time frame 29. Accordingly, the Y coordinate at this time frame (Y29) was also added as a predictor.

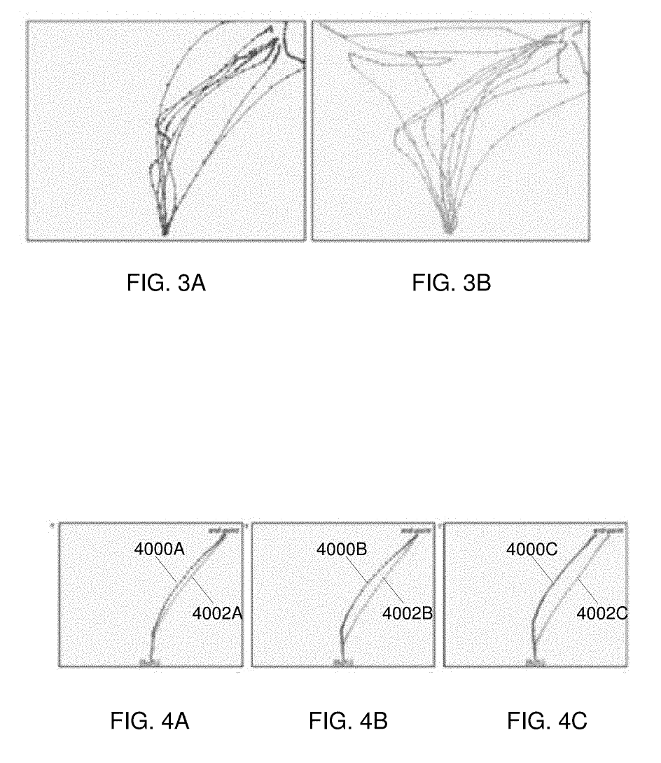

FIG. 2A and FIG. 2B respectively depict the prototypical trajectories of a truth-teller to control and unexpected questions. FIG. 3A and FIG. 3B respectively depict the prototypical trajectories of a liar to control and unexpected questions. Specifically, these show the responses of individual mouse trajectories in response to control questions and unexpected questions collected from a prototypical truth-teller and a prototypical liar.

Trajectories refer to responses to single questions. Note that this liar is responding truthfully to control questions. Nonetheless, his response as depicted in FIG. 3A diverges from the direct trajectory that ideally characterizes a truthful response. This generalization of the liar mindset when the liar is responding to questions that require truthful responses is discussed in the paper.

Disaggregation of Responses to Control, Expected and Unexpected Questions.

The subjects' performances were separately analyzed for control, expected, and unexpected questions. FIGS. 4A, 4B and 4C respectively depict the trajectory for control, expected, and unexpected questions for both liars (4000A, 4000B, and 4000C) and truth-tellers (4002A, 4002B, and 4002C). The trajectory of liars and truth-tellers in control questions as depicted in FIG. 4A are almost overlapping. The maximum difference in trajectory is observed again in response to unexpected questions in FIG. 4C.

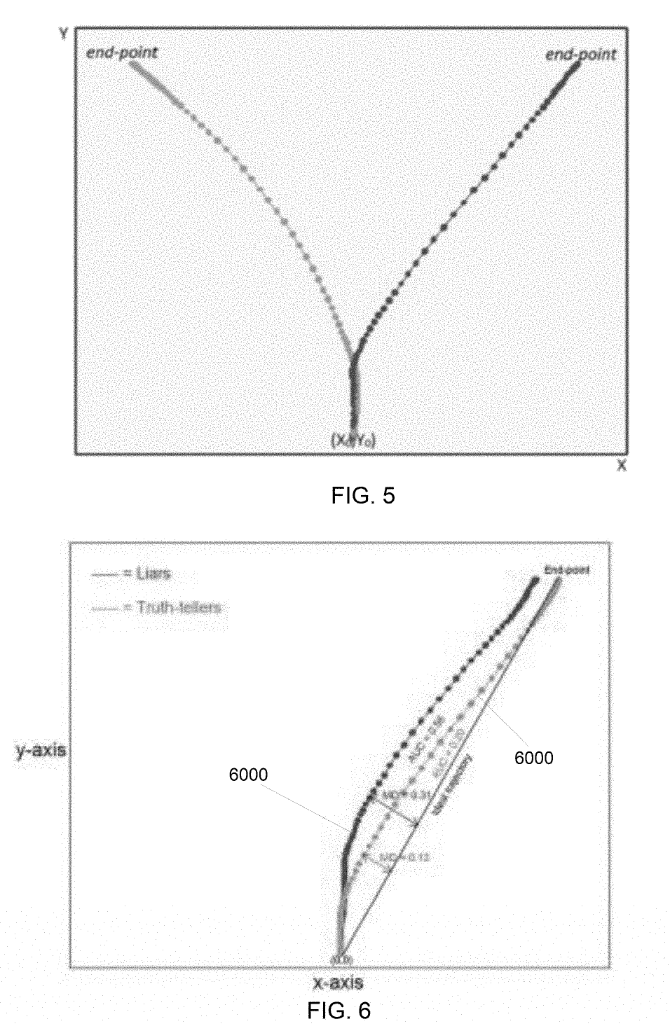

YES and NO responses were disaggregated to investigate whether there is a difference in the trajectory and in response time between the questions to which subjects responded by moving a mouse to the right (questions requiring a NO response) and questions to which subjects responded moving a mouse to the left (questions requiring a YES response). The t-tests on the whole sample were carried out in order to compare left and right responses. No statistically significant difference was found both for MD-time (t=1.63; p=0.1; Cohen's d=0.2; BF=0.57) and Y29 (t=0.1; p=0.9; Cohen's d=0.01; BF=0.17). For AUC, the following results were obtained: t=−2.09 and p=0.04, but the Cohen's d value showed a small effect size (d=−0.33), and the Bayes Factor approached (BF=1.2). In FIG. 5, trajectories of the left and right responses are reported. It can be noted that the two curves follow a very similar, albeit specular, trajectory.

### Descriptive Statistics of Independent Variables

Feature selection isolated, from an original set of 13 predictors, 4 independent variables: errors, AUC, MD-time, and Y29. These were highly correlated with the group (truth-teller/liar). Table 3 reports descriptive statistics as well as analysis of the difference between truth-tellers and liars as demonstrated by t-test, Cohen's d and Bayes Factor.

TABLE 3
Descriptive statistic of the 13 independent variables.

| | | | | | | | | Bayes Factor | |
|---|---|---|---|---|---|---|---|---|---|
| | Mean (SD) | | | | t-test | | Cohen's d | Kass and Raftery | |
| | Liars | | Truth-tellers | | t-value | p-value | d-value | Interpretation | |
| Errors | 0.13 | (±0.09) | 0.01 | (±0.02) | 5.83 | <0.01 | 1.84 (large) | >150 | (very strong) |
| AUC | 0.60 | (±0.38) | 0.22 | (±0.21) | 3.09 | <0.01 | 1.23 (large) | 70.41 | (strong) |
| MD time | 1264.33 | (±377.78) | 951.92 | (±219.62) | 3.19 | <0.01 | 1.01 (large) | 13.52 | (positive) |
| Y29 | 0.27 | (±0.23) | 0.11 | (±0.08) | 2.93 | <0.01 | 0.92 (large) | 7.66 | (positive) |

Errors, AUC, MD-time, and Y29 were selected as the independent variables with maximum correlation with the group and minimal correlation among them. Average values are reported along with SD in parentheses and t-tests, Cohen's d and Bayes Factor.

### Machine Learning Models

Several machine learning (ML) classifiers were tested using a 10-fold cross-validation procedure as implemented by WEKA. Four classifiers were selected that differ based on their assumptions: Random Forest, Logistic, Support Vector Machine (SVM) and Logistic Model Tree (LMT). The 10-fold cross-validation was carried out as follows: the group of participants (40 subjects) was randomly subdivided in 10 subgroups of 4 subjects each. In each run, one of the 10 subsamples was retained as test set to evaluate the model and the remaining 9 were used as training data. The cross-validation process was then repeated 10 times so that each of the 10 subsets of participants were used exactly 1 time as validation set. The 10 results on the test set were then averaged to produce a single estimation of accuracy. The results are reported in Table 4. All of the classifiers reached an accuracy of around 90% or higher in classifying liars and truth-tellers. A minimum of 36/40 subjects were correctly classified. The Logistic classifier reached an accuracy of 95% (38/40 participants correctly classified). Comparable results have been obtained using a leave-one-out cross-validation (LOOCV).

TABLE 4
Classification accuracy in the 10-fold cross-validation and
in the validation sample.

| ML classifier | Cross-validation | Validation sample | Misclassified |
|---|---|---|---|
| Random Forest | 92.5% | 95% | 1/20-1 truth-teller |
| Logistic | 95% | 95% | 1/20-1 truth-teller |
| SVM | 90% | 95% | 1/20-1 liar |
| LMT | 92.5% | 95% | 1/20-1 truth-teller |

The accuracy in the 10-fold cross-validation is reported for four different ML classifiers: Random Forest, Logistic, Support Vector Machine (SVM), and Logistic Model Trees (LMT). Moreover, the table reports the accuracy percentages obtained in testing the previous models on a new sample of 20 participants and the number of misclassified subjects. Random Forest and LMT misclassified the same truth-teller, whereas Logistic misclassified a different one and SVM misclassified a liar.

As reported in Table 5, the classification models have both high specificity and high sensitivity. In fact, in the validation samples the classification errors are equally distributed in the two classes.

TABLE 5
Sensitivity and specificity of the classification models in the
10-fold cross-validation and in the validation sample.

| | Cross-validation | | Validation sample | |
|---|---|---|---|---|
| ML classifier | Specificity | Sensitivity | Specificity | Sensitivity |
| Random Forest | 95% | 95% | 100% | 95% |
| Logistic | 97.5% | 95% | 100% | 95% |
| SVM | 100% | 100% | 95% | 100% |
| LMT | 92.5% | 100% | 100% | 95% |

Sensitivity and specificity in the 10-fold cross-validation and in the validation sample are reported for the four different ML classifiers: Random Forest, Logistic, Support Vector Machine (SVM), and Logistic Model Trees (LMT).

Model Evaluation: Out-of-Sample Performance of 20 Italian Participants.

After the development of the ML classifiers described above, a further sample of 20 participants (10 liars and 10 truth-tellers) was collected and tested using the models previously developed based on the original 40 participants. This group of participants was a totally new group that had never been used before for the analysis or model building. This procedure is regarded as an optimal strategy to avoid overfitting. The classification accuracies on this new sample are reported in Table 4. It is worth noting that the classification accuracy remained stable, also across the classifiers, even in this validation sample.

To better understand the contribution of control, expected, and unexpected questions in the classification three separate models for each type of question were run. As shown in Table 6, results indicate that the major contribution derives from unexpected questions. Classification accuracies using ML classifiers confirm that it is not possible to efficiently distinguish liars from truth-tellers solely based on control questions. The same is true also for expected questions although, in this case, the trajectories of the two groups seem to be more separated, as shown in FIG. 4B. Using only unexpected questions, classification accuracy reaches its maximum with figures above 90%, also in the validation sample, confirming that the cognitive load of liars, due to unexpected questions, is at the origin of the difference between the two groups.

TABLE 6
Classification accuracy for control, expected, and unexpected questions.

| | | 10-fold | Validation |
|---|---|---|---|
| | Classifiers | cross-validation | sample accuracy |
| Type of questions | using | accuracy (n = 40) | (n = 20) |
| Control | Random Forest | 62.5% | 30% |
| | Logistic | 60% | 60% |
| | SVM | 55% | 55% |
| | LMT | 50% | 60% |
| Expected | Random Forest | 65% | 55% |
| | Logistic | 67.5% | 50% |
| | SVM | 65% | 55% |
| | LMT | 65% | 55% |
| Unexpected | Random Forest | 87.5% | 100% |
| | Logistic | 95% | 95% |
| | SVM | 92.5% | 90% |
| | LMT | 95% | 90% |

Classification accuracy using control, expected, and unexpected questions for each of the classifiers.
Predictors were errors, AUC, MD-time, and Y29.

The relative weight of the predictors was investigated by eliminating the independent variables one by one and rerunning the classifiers. The results indicated that after eliminating the errors from the predictors, the classification accuracy dropped to around 75% for the cross-validation and around 70% for the test procedure (Random Forest: cross-validation=70%, test=65%; Logistic: cross-validation=77.5%, test=70%; SVM: cross-validation=75%, test=65%; LMT: cross-validation=75%, test=70%). The major contribution in prediction accuracy comes from revealing errors to unexpected questions with mouse dynamic features fine tuning an already good classification. This is clear if we consider that predictions based solely on errors yielded the following results: Random Forest: cross-validation=77.5%, test=100%; Logistic: cross-validation=82.5%, test=100%; SVM: cross-validation=80%, test=95%; LMT: cross-validation=85%; Test=100%. After dropping AUC from the predictors, the classification accuracy remained stable in the test set and fell to 90% during cross-validation (Random Forest: cross-validation=90%, test=95%; Logistic: cross-validation=95%, test=95%; SVM: cross-validation=85%, test=95%; LMT: cross-validation=90%, test=100%). Similar results were obtained when removing MD-time from the predictors (Random Forest: cross-validation=90%, test=95%; Logistic: cross-validation=90%, test=95%; SVM: cross-validation=87.5%, test=85%; LMT: cross-validation=90%, test=95%). Finally, after discharging Y29 from the predictors, the accuracy both in the training and the test sets decreased slightly (Random Forest: cross-validation=92.5%, test=95%; Logistic: cross-validation=95% test=95%; SVM: cross-validation=92.5%, test=85%; LMT: cross-validation=92.5%, test=95%).

Briefly, the relative importance of the independent variables indicated that the total number of errors gave the major contribution in correctly distinguishing liars from truth-tellers, followed by the MD-time, the AUC, and the position of the mouse along the y-axis on the 29th time frame.

Error Analysis.

The errors to control and expected questions are virtually absent in truthtellers (see Table 7). Liars and truth-tellers made most of the errors to unexpected questions. The average liar makes 12.4 times the number of errors to unexpected questions with respect to truth-tellers. Liars and truth-tellers make no errors to control questions and only a total 2/240 to expected questions. The difference between the two groups arises from unexpected questions with truth-tellers making a total 5/240 errors and liars 82/240. This indicates that for every error made by a truth-teller to unexpected questions liars make 16 errors. It is worth noting that liars make more errors to unexpected YES (60/120 where they lie) rather than unexpected NO (22/120 where they respond truthfully), t=−4.59, p<0.01; Cohen's d=1.60; BF=16.42.

TABLE 7
Analysis of errors.

| Type of questions | | Liars (n = 20) | Truth-tellers (n = 20) |
|---|---|---|---|
| Control | Total number of errors/160 stimuli | 0/160 | 0/160 |
| (n = 320 stimuli) | Errors mean | 0 | 0 |
| | Errors SD | 0 | 0 |
| Expected | Total number of errors/240 stimuli | 2/240 | 2/240 |
| (n = 480 stimuli) | Errors mean | 0.008 | 0.008 |
| | Errors SD | 0.091 | 0.091 |
| Unexpected all | Total number of errors/240 stimuli | 82/240 | 5/240 |
| (n = 480 stimuli) | Errors mean | 0.341 | 0.020 |
| | Errors SD | 0.475 | 0.143 |
| Unexpected YES | Total number of errors/120 stimuli | 60/120 | 5/120 |
| (n = 240 stimuli) | Errors mean | 0.5 | 0.042 |
| | Errors SD | 0.502 | 0.201 |
| Unexpected NO | Total number of errors/120 stimuli | 22/120 | 0/120 |
| (n = 240 stimuli) | Errors mean | 0.183 | 0 |
| | Errors SD | 0.389 | 0 |

Errors to control, expected, and unexpected questions for liars and truth-tellers. YES and NO responses are reported for unexpected questions.

German Validation Sample.

To check whether the model can efficiently classify participants from different cultures, 20 German subjects were tested (10 liars and 10 truth-tellers) with good results. To address the effects of culture on the generalization of results, a sample of 20 participants who were native speakers of German in Dusseldorf (10 truth-tellers and 10 liars; average age=29.5 years; males=9/20) were tested with questions in German. Participants provided informed consent before the experiment. Results from this group were evaluated using the model originally trained on the 40 Italian participants. The classification accuracy was the following: Random Forest=95%, Logistic=100%, SVM=90%, LMT=95%. Errors analysis (see Table 8) indicates that the proportion of errors in liars and truth-tellers is comparable in the two groups (Italian n=40 and German n=20) with results for liars of t=−1.4, p=0.17 (Cohen's d=−0.49, BF=0.64) and results for truth-tellers of t=0.66, p=0.52 (Cohen's d=0.28, BF=0.43).

TABLE 8
Proportion of errors in liars and truth-tellers in
the Italian and German samples.

| | | |
|---|---|---|
| Sample | Average number of errors | Total number of errors |

Italian Sample (n = 40)

| | | |
|---|---|---|
| Liar | 0.13/32 | 84/640 |
| Truth-tellers | 0.01/32 | 7/640 |

German Sample (n = 20)

| | | |
|---|---|---|
| Liar | 0.17/32 | 55/320 |
| Truth-tellers | 0.006/32 | 2/320 |

The table reports the average and total number of errors in liars and truth-tellers of the Italian and German samples.

The experimental design described in these experiments required that liars lie only when responding YES to expected and unexpected YES questions. In all of the other conditions (expected NO, unexpected NO, control YES, and control NO questions), the liars responded truthfully (see Table 2). An interesting question is whether the liars could also be spotted from their truthful responses. In the previous section, the response trajectories of the two groups to expected and unexpected questions that required a YES response were compared as discussed in connection with FIG. 1. Here, the trajectories of the two groups for the responses that required a NO response and for all of the control questions are compared. The trajectories for when the liars responded truthfully are reported at 6000 in FIG. 6. Although the difference is reduced if compared with the responses for which the liars were lying, the differences with the trajectories for the truth-tellers 6002 are still detectable (AUCs of 0.58 vs 0.20 and MDs of 0.31 vs 0.13).

In order to evaluate whether the trajectories of the liars also differed from those of the truth-tellers when they were not lying, the two experimental groups were compared on the independent variables previously used in developing the classifiers. The results of the independent t-test, reported in Table 9, indicate that the liars' response styles may be identified even when the liars were responding truthfully. The classifiers had the following accuracy rates in identifying liars and truth-tellers on the sole basis of responses to questions to which the liars responded truthfully: Random Forest=77.5%, SVM=80%, Logistics=80% and LMT=77.5%. All of the classifiers clearly were relatively accurate, even if below the classification accuracy based only on YES responses to expected and unexpected questions (which was in the range of 90±92%).

TABLE 9
Statistics for question when the liars responded truthfully and for questions when the
liars responded falsely.

| | | Expected and unexpected NO |
|---|---|---|
| Feature | Expected and unexpected YES questions | questions, and control questions |
| Number of | t = 6.06, p < 0.01, d = 1.91, BF >150 | t = 3.44, p < 0.01, d = 1.09, BF = 23.11 |
| errors | | |
| AUC | t = 3.46, p < 0.01, d = 1.09, BF = 24.46 | t = 3.36, p < 0.01, d = 1.06, BF = 19.63 |
| MD-time | t = 3.42, p < 0.01, d = 1.08, BF = 22.03 | t = 2.65, p < 0.02, d = 0.83, BF = 4.37 |
| Y29 | t = 2.63, p < 0.02, d = 0.83, BF = 4.26 | t = 2.98, p < 0.01, d = 0.94, BF = 8.51 |

The table reports the independent t-test analysis, Cohen's d and Bayes Factor statistics when the liars responded falsely (expected and unexpected YES questions) and for questions when the liars responses truthfully (expected and unexpected NO questions and control questions). The table reports t-values, p-values, Cohen's d and Bayes Factor value for the four features that showed a high correlation with the dependent variable (liars vs truth-tellers).

Both statistical analysis and ML analysis have shown that the markers of lying extended to questions to which they responded truthfully. Even when responding truthfully, the liars could be identified, but with lower accuracy. From a cognitive point of view, what is interesting here is that, in the experimental design, the mind-set of the liars also extended its effects to questions when they were responding truthfully. To our knowledge, this pattern of results has never been reported before and could be an indication of the level of sensitivity of the technique of mouse-movement analysis.

### Example 2—Detection of Faked Identity Using Unexpected Questions and Keyboard Dynamics

In this experiment, similar to the experimental design in Example 1, above, unexpected questions were used to increase the cognitive load (especially for liars) with a different computer input device analyzed to capture the cognitive difference. Given that lying taps further into working memory than truth telling, it was expected that keystroke dynamics would reflect this cognitive difference, resulting in longer reaction times (RT) and more errors in liars relative to truth tellers, especially in response to unexpected questions. Further it was expected that a greater variability in liars' typing patterns and, conversely, minor deviations from average values in truth tellers' typing patterns would be detected. This experiment is reported in Monaro et al., SCIENTIFIC REPORTS (2018) 8:1976|DOI:10.1038/s41598-018-20462-6, accessible through www.nature.com/scientificreports, and the contents of which are incorporated herein by reference in its entirety.

The experiment was conducted in the laboratories of the School of Psychology at Padua University using a single laptop ASUS F552WE-SX039 15.6″ in order to avoid possible device-specific variation. The experiment was run from a website built using PHP, HTML and JavaScript. Recording of keystrokes and intervals was programmed using JavaScript. Through the website, the responses of 60 individuals who completed an edit box presented below a presented sentence by writing in the edit box with the appropriate autobiographical information and then finishing the response by pressing enter were collected. Data were stored via MySQL Ver 14:14 Database. Finally, data were analyzed using R for preliminary descriptive statistical analysis and WEKA for developing the machine-learning (ML) models trained to classify whether the collected response was that of a truth teller or that of a liar.

For the sake of clarity, ML refers to the study and construction of algorithms that can learn information from a set of data (called a training set) and make predictions for a new set of data (called a test set). ML is now the basis for a large number of applications, such as the self-driving cars, speech recognition (e.g. Siri), recommender systems, etc. It enables the training of one or more algorithms to predict outcomes without being explicitly programmed and only uses the information learned from the training set. Usually, ML models outperform traditional statistical models.

Participants. A first sample of 40 participants—12 males and 28 females—was recruited (average age=23 years [sd=1.9], average education level=17 years [sd=1.8]). These 40 participants were used to preliminarily build an ML classification model (training set). When the model was built, a new group of 20 participants—6 males and 14 females—was recruited to test the classification model (test set: average age=22 years [sd=1.7], average education level=16 years [sd=1.6]).

All participants signed an informed-consent agreement. A photo of each participant's face was taken and pasted on a standard Italian ID card together with the personal information of the participant. Debriefing at the end of the experiment was carried out. The experimental procedure was approved by the ethics committee for psychological research in the Padova University Psychology Department. The experiment was performed in accordance with relevant guidelines and regulations.

Experimental Procedure and Stimuli.

The experimental procedure was similar to that set forth in Example 1. 20 participants were instructed to answer truthfully, while the others were instructed to lie about their identity according to a false autobiographical profile which was presented on the fake ID card displaying the participant's real photo and false personal information. After the learning phase, participants were required to correctly recall the information presented on the ID card twice; they performed a mental-arithmetic task in between. This multistep procedure ensured the investigator that liars actually learned their assigned false personal information.

For both experimental groups, the task required answering 18 open-ended questions related to identity. Table 10 reports the list of presented questions. The 18 sentences were displayed on the central area of the screen. The participants would then fill out an edit box presented below the presented sentence and then finish the response by pressing the ENTER key. A bar in the lower part of the computer screen indicated the percentage of the test completed at any given moment.

TABLE 10

| Question | |
|---|---|
| type | Question Text |
| Control | What is your gender? |
| | What is the colour of your skin? |
| | What is the colour of your hair? |
| | What is your nationality? |
| Expected | What is your name? |
| | What is your last name? |
| | In which year were you born? |
| | In which month were you born? |
| | In which city were you born? |
| | In which city do you live? |
| | What is your home address? |
| | What is your e-mail address? |
| Unexpected | How old are you? (in letters) |
| | Which is your zodiac? |
| | In which region were you born? |
| | In which province were you born? |
| | In which region do you live? |
| | What is the capital town of your residence region? |

Before starting the experiment, participants completed a warm-up block consisting of three questions. Data collected from the warm-up block were not further analyzed.

The 18 questions, randomly presented to subjects, belonged to the following categories:
(1) Control questions (n=4): these included personal and physical information that was not possible to hide from the examiner in the face-to-face experimental setting (e.g. “are you a male?”). All participants, including liars, responded to these questions truthfully.
(2) Expected questions (n=8): these were questions targeting information that appeared on the ID card. In the case of liars, the answers to these questions about their fake IDs were learned in the preliminary part of the experiment. Truth tellers responded truthfully to these questions while liars were required to lie and provide the information found on their fake ID.
(3) Unexpected questions (n=6): unexpected questions were based on information strictly related to identity but not explicitly rehearsed in the preliminary phase by truth tellers or by liars. Truth tellers responded to these questions referring to their real identity, while liars responded referring to their assigned fake identity. The control, expected, and unexpected questions shown to participants during the experiment are reported in Table 10. Typical response length ranged between 1 and 4 words. The total duration of the task was about 10-15 minutes.

For each response, the following data were collected and stored for analysis:
Number of errors: this refers to the total number of errors committed by the person in answering the 18 questions. Specifically, error means the number of fields for which incorrect information was entered. Errors were calculated by checking each response given by the subject against the conceptually correct information. Only conceptual errors were considered for three reasons. First, other types of errors, such as typing errors, were rarely detected because of the low number of words required by the responses. Second, when encountered, such errors were minimal, thereby not affecting the conceptual correctness of the answer. Third, an indirect measure of typing errors was already given by the use frequency of special characters, such as Del and Canc keys. An example reported as a conceptual error was the answer “Capricorn” when the corresponding date of birth of the learned profile was the Dec. 2, 1988. Another example based on the same date of birth would be the answer “22” to a question related to age. Most conceptual errors were detected in unexpected questions, when the subjects, truth tellers or liars, were required to compute the unexpected information asked from the known data written on their own profile (real or assigned/fake).
Prompted-first digit: this refers to the interval between the onset of the sentence on the computer screen and the first key pressed. This index was subsequently adjusted using a readability index for the Italian language (GULPEASE Index) in order to refine the reaction time by weighting the latency of the response to the question for the difficulty of reading the question. GULPEASE is an index which takes into account the length of the sentence read.
Prompted-enter: this refers to the total time from the stimulus onset to ENTER (pressed at the end of the response).
Firstdigit-enter: this refers to the time between the first key and ENTER.
Time before enter key: this refers to the time between last key and ENTER.
Answer length: this refers to the number of characters of the response.
Writing time: this refers to the average typing speed (firstdigit-enter/number of characters).
Down time: this refers to the timestamp for pressing each key.
Up time: this refers to the timestamp for releasing each key.
Up and down time: this refers to the sum of down time and up time for each key.
Press time: this refers to the duration between each key down and each key up.
Flight time: this refers to the interleaving time between each key up and the next key down.
Di-graphs: these refer to the sum of up time, down time or up and down time for two consecutive keys.
Tri-graphs: these refer to the sum of up time, down time or up and down time for three consecutive keys.
Frequency of use for special characters: this refers to the total number of key pressing for Shift, Del and Canc, Space and Arrows characters.
We calculated a total of 62 attributes for each subject, averaging each variable over the 18 responses given by each subject. The complete list of the 62 attributes is:
Number of errors
Prompted-firstdigit
Prompted-firstdigit adjusted GULPEASE
Prompted-enter
Firstdigit-enter
Time before enter key down
Time before enter key flight
Answer length
Writing time
Di-graph down time average
Di-graph down time maximum
Di-graph down time minimum
Di-graph down time median
Di-graph down time standard deviation
Di-graph down time variance
Di-graph up time average
Di-graph up time maximum
Di-graph up time minimum
Di-graph up time median
Di-graph up time standard deviation
Di-graph up time variance
Di-graph up and down time average
Di-graph up and down time maximum
Di-graph up and down time minimum
Di-graph up and down time median
Di-graph up and down time standard deviation
Di-graph up and down time variance
Di-graph press time average
Di-graph press time maximum
Di-graph press time minimum
Di-graph press time median
Di-graph press time standard deviation
Di-graph press time variance
Di-graph flight time average
Di-graph flight time maximum
Di-graph flight time minimum
Di-graph flight time median
Di-graph flight time standard deviation
Di-graph flight time variance
Tri-graph down time average
Tri-graph down time maximum
Tri-graph down time minimum
Tri-graph down time median
Tri-graph down time standard deviation
Tri-graph down time variance
Tri-graph up time average
Tri-graph up time maximum
Tri-graph up time minimum
Tri-graph up time median
Tri-graph up time standard deviation
Tri-graph up time variance
Tri-graph up and down time average
Tri-graph up and down time maximum
Tri-graph up and down time minimum
Tri-graph up and down time median
Tri-graph up and down time standard deviation
Tri-graph up and down time variance
Number of Shift
Number of Del
Number of Canc
Number of Space
Number of Arrows

Average, maximum, minimum, median, standard deviation and variance were calculated and statistically analyzed for a preliminary identification of significant differences between truth tellers and liars.

Results and Statistical Analysis.

A first analysis was carried out by examining the statistical differences in the collected data for truth tellers and liars through independent t-test. A Welch's t-test (included in the R software ‘lsr’ package), which adjusts the number of degrees of freedom when the variances are not assumed to be equal was calculated. To avoid the multiple-testing problem, the Bonferroni correction was applied, and the p-value was set to 0.0008. Furthermore, the Cohen's d effect size was calculated. Results are presented in Table 11.

TABLE 11

| | t-test | |
|---|---|---|
| Feature | (t-value and p-value) | Effect-size (Cohen's d) |
| Errors | T₍₂₁₎ = −10.57, p < 8e−4 | D = 3.34 (large) |
| Prompted-firstdigit | T₍₃₁₎ = −6.34, p < 8e−4 | D = 2.00 (large) |
| Prompted-firstdigit | T₍₃₀₎ = −6.48, p < 8e−4 | D = 2.05 (large) |
| Adjusted GULPEASE | | |
| Prompted-enter | T₍₂₆₎ = −5.46, p < 8e−4 | D = 1.73 (large) |

This analysis revealed that liars make more errors, are slower in initiating their responses and are slower in total response time (from the stimulus onset to the confirmation of the response as characterized by pressing ENTER). No other variables collected reached a statistically significant value in the t-test.

The error rate was analyzed separately for control, expected and unexpected stimuli. The analysis yielded the results reported in Table 12: the error rate is similar when responding to control and expected questions. In contrast, when responding to unexpected questions, liars produced 27 times more errors than truth tellers.

TABLE 12

| Question type | Truthtellers | Liars |
|---|---|---|
| Control | 0/80 | 0/80 |
| Expected | 0/160 | 3/160 |
| Unexpected | 3/120 | 81/120 |

Feature Selection.

It has been suggested that classifier accuracy is enhanced by selecting a subset of predictors which have maximum correlation with the dependent variable and minimal intercorrelation between features. Based on these criteria, in a first-features selection step, the predictors that show maximum correlation with the dependent variable were selected. These predictors were as follows: number of errors (rpb=0.85), prompted-firstdigit adjusted for the GULPEASE index (rpb=0.71), prompted-firstdigit (rpb=0.70), prompted-enter (rpb=0.65), firstdigit-enter (rpb=0.46), writing time (rpb=0.50) and time before enter key down (rpb=0.43). In a second step, the intercorrelation between these seven features was examined. Two of the seven predictors (prompted-firstdigit and prompted-enter) showed a very high correlation value, respectively, with prompted-firstdigit adjusted GULPEASE (rpb=0.99) and firstdigit-enter (rpb=0.89). Hence, to avoid redundancy, these features have been excluded. The five final attributes of the feature selection considered for the purposes of classification are described, as are their correlations, in Table 13. The entire correlation matrix between features and dependent variable can be found in the repository: https://github.com/SP RITZ-Research-Group/Covert_lie_detection_using_keyboard_dynamics which is incorporated herein by reference in its entirety.

TABLE 13

| | | | | | Time | |
|---|---|---|---|---|---|---|
| | | Prompted- | | | key | |
| | Number | firstdigit | | | before | |
| | of | adjusted | Firstdigit- | Writing | enter | Fea- |
| Feature | Errors | GULPEASE | enter | time | down | ture |
| Number of | 1.00 | 0.51 | 0.25 | 0.46 | 0.44 | 1.00 |
| Errors | | | | | | |
| Prompted- | 0.51 | 1.00 | 0.66 | 0.60 | 0.54 | 0.51 |
| firstdigit | | | | | | |
| adjusted | | | | | | |
| GULPEASE | | | | | | |
| Firstdigit- | 0.25 | 0.66 | 1.00 | 0.67 | 0.52 | 0.25 |
| enter | | | | | | |
| Writing time | 0.46 | 0.60 | 0.67 | 1.00 | 0.67 | 0.46 |
| Time key | 0.44 | 0.54 | 0.52 | 0.67 | 1.00 | 0.44 |
| before | | | | | | |
| enter down | | | | | | |

Classifier Performance.

Classifiers were run in WEKA, an ML software. Four different classifiers were trained via a 10-fold cross-validation procedure using data from the first 40 participants as a training set. Four classifiers were selected that differ based on their assumptions. Random forest operates by constructing a multitude of decision trees. Logistic regression measures the relationship between the categorical dependent variable and one or more independent variables by estimating probabilities using a logistic function. Support vector machine (SVM) is a non-probabilistic binary linear classifier which maps the space, so the examples of the separate categories are divided by a clear gap that is as wide as possible. Logistic model tree (LMT) combines logistic regression and decision-tree learning.

Finally, to evaluate the generalization of the results for completely new data, models were tested on 20 new participants not previously used in the learning phase. Accuracies obtained by the classifiers during training and testing are reported in Table 14.

TABLE 14

| | | | | | | | | |
|---|---|---|---|---|---|---|---|---|
| | | | | | | F- | | |
| | | TP | FP | Pre- | Re- | Mea- | ROC | PRC |
| Classifier | Accuracy | Rate | Rate | cision | call | sure | Area | Area |

10-fold cross-validation

| | | | | | | | | |
|---|---|---|---|---|---|---|---|---|
| Logistic | 90% | 0.900 | 0.100 | 0.904 | 0.900 | 0.900 | 0.959 | 0.948 |
| SVM | 95% | 0.950 | 0.050 | 0.950 | 0.950 | 0.950 | 0.950 | 0.928 |
| (SMO) | | | | | | | | |
| LMT | 97.5% | 0.975 | 0.025 | 0.976 | 0.975 | 0.975 | 1.000 | 1.000 |
| Random | 92.5% | 0.925 | 0.075 | 0.926 | 0.925 | 0.925 | 0.972 | 0.972 |
| Forest | | | | | | | | |

Test

| | | | | | | | | |
|---|---|---|---|---|---|---|---|---|
| Logistic | 100% | 1.000 | 0.000 | 1.000 | 1.000 | 1.000 | 1.000 | 1.000 |
| SVM | 90% | 0.900 | 0.100 | 0.917 | 0.900 | 0.899 | 0.900 | 0.867 |
| (SMO) | | | | | | | | |
| LMT | 90% | 0.900 | 0.100 | 0.917 | 0.900 | 0.899 | 1.000 | 1.000 |
| Random | 95% | 0.950 | 0.050 | 0.955 | 0.950 | 0.950 | 1.000 | 1.000 |
| Forest | | | | | | | | |

In order to highlight the relative importance of predictors in classification accuracy, the predictors were eliminated one by one and the classification accuracy recalculated. This analysis yielded the following results:
Errors: errors are a key attribute, as the results indicated that eliminating errors from predictors led to a decrease in classification accuracy around 80% for the cross-validation and around 68% for the test.
Prompted-firstdigit: when this predictor is eliminated with its related variables (such as prompted-firstdigit and prompted-enter), the overall accuracy remains substantially high (around 90% for training and around 95% in the test). Furthermore, these results are similar for different classifiers.
Firstdigit-enter, writing time and time before enter key down: when eliminating the firstdigit-enter variable using the predictors, the accuracy remains high (around 94.5% for the cross-validation and around 92.5% for the test). The same occurs when removing the writing time and time key before enter down.

The accuracy obtained for each classifier and all classification metrics were calculated. In short, errors are the single most important predictor in identifying a liar for this ID test. Furthermore, the variables related to response latency (prompted-firstdigit adjusted GULPEASE), the writing time (firstdigit-enter and writing time) and the interval between the last key press and the confirmation of the response (time before enter key down) also contributed significantly to the identification of liars.

All these analyses were conducted taking into account the responses to all three types of questions (control, expected and unexpected). Control questions were specifically analyzed separately as both liars and truth tellers were required to respond truthfully to control questions. All classifiers yielded a classification around chance level for this type of question (47.5% for cross-validation and 50% for the test), and this result indicates that responses to control questions between the two groups were virtually indistinguishable.

Analysis of Normalized Predictors.

One could argue that keyboard dynamics are modulated by a number of different variables such as age, cultural level and typing skills. Hence, the analyses reported above were conducted on raw data using two groups of subjects similar in age, cultural level and typing skills. In order to render the results generalizable, it would be interesting to see whether similar results hold not only for raw data but also for normalized predictors. To overcome this limitation, the classification models were run again using only normalized indices, less influenced by inter-individual and environmental variables. These indices were:
Average number of errors (number of errors/total number of questions)
Writing time (firstdigit-enter/answer length)
Prompted-firstdigit−prompted-enter (prompted-firstdigit minus prompted-enter)
Writing time/prompted-firstdigit−prompted-enter [writing time/(prompted-firstdigit minus prompted-enter)]

Results from the five classifiers using the normalized predictors are reported in Table 15. In short, the high degree of accuracy in classifying truth tellers and liars is also confirmed for normalized predictors. In addition to accuracies, Table 16 reports the weight average of Ture Positive Rate (TPR), False Positive Rate (FPR), Precision value, Recall value, F-Measure, Receiver Operating Characteristics (ROC), Area value, and Precision-recall Curve (PRC) Area value.

TABLE 15

| | | | | | | | | |
|---|---|---|---|---|---|---|---|---|
| | | | | | | F- | | |
| | | TP | FP | Pre- | Re- | Mea- | ROC | PRC |
| Classifier | Accuracy | Rate | Rate | cision | call | sure | Area | Area |

10-fold cross-validation

| | | | | | | | | |
|---|---|---|---|---|---|---|---|---|
| Logistic | 90% | 0.900 | 0.100 | 0.900 | 0.900 | 0.900 | 0.946 | 0.912 |
| SVM | 92.5% | 0.925 | 0.075 | 0.935 | 0.925 | 0.925 | 0.925 | 0.897 |
| (SMO) | | | | | | | | |
| LMT | 90% | 0.900 | 0.100 | 0.917 | 0.900 | 0.899 | 0.985 | 0.986 |
| Random | 95% | 0.950 | 0.050 | 0.950 | 0.950 | 0.950 | 0.966 | 0.961 |
| Forest | | | | | | | | |

Test

| | | | | | | | | |
|---|---|---|---|---|---|---|---|---|
| Logistic | 100% | 1.000 | 0.000 | 1.000 | 1.000 | 1.000 | 1.000 | 1.000 |
| SVM | 90% | 0.900 | 0.100 | 0.917 | 0.900 | 0.899 | 0.900 | 0.867 |
| (SMO) | | | | | | | | |
| LMT | 90% | 0.900 | 0.100 | 0.917 | 0.900 | 0.899 | 1.000 | 1.000 |
| Random | 100% | 1.000 | 0.000 | 1.000 | 1.000 | 1.000 | 1.000 | 1.000 |
| Forest | | | | | | | | |

Countermeasures and Alternative Efficient Models.

Resistance to countermeasures is a central issue for all available lie-detection techniques. While this experiment did not directly test resistance to countermeasures, a number of reasons indicate that coaching subjects could be difficult, particularly as pertains to: (1) Errors to unexpected questions are diagnostic of lying, and the subjects should respond without errors in order to cheat the test, However, this seems impossible as subjects are already performing at their maximum level. There are no easy countermeasures to the number of errors; therefore, countermeasures are limited by keystroke dynamics. (2) Parameters used to encode keystroke dynamics and correlate with the dependent variable are high in number, and only some were used in building the original model. It is unlikely that the cheater succeeds in implementing countermeasures that simultaneously remain under voluntary control for all possible efficient predictors.

To highlight these points, a model was tested that uses the following as predictors: (rpb=0.85), prompted-firstdigit (rpb=0.70), prompted-enter (rpb=0.65), time before enter key flight (rpb=0.43) and di-graph down time average (rpb=0.38) (note that the predictors used in the original analysis reported above included errors, prompted-firstdigit adjusted GULPEASE, firstdigit-enter, writing time and time before enter key down). Results for the new set of predictors for the sample of 40 participants are as follows (results with 10-fold cross-validation): Random Forest=90%, Logistics=92.5%, SVM=95% and LMT=97.5%. Results for the 20 participants of the validation sample were as follows: Random Forest=90%, Logistics=100%, SVM=90% and LMT=90%. These results clearly show that there are other sets of predictors that can be used to efficiently classify the participants and that it is hard to countermeasures to control the entire set of efficient predictors.

Classification of Liars Using Only Data from Truth Tellers.

While liars were instructed to lie about their identity, truth tellers were instructed to respond freely without any specific instructions. Under this view, liars are responding in an anomalous way with respect to truth tellers. Normally, in a real situation, the majority of the subjects report true identities; only a few provide false information and show an anomalous pattern of response. In order to evaluate whether liars may still be identified based on their anomalous response style, an ML technique called anomaly detection was applied. Anomalies are data that have different patterns relative to normal instances. The detection of anomalies provides significant information and has applications in many fields. For example, the detection of anomalies is used in credit-card transactions, astronomical images or nuclear-plant functioning. Anomaly-detection techniques classify subjects after a training limited to the most frequent group, in our experiment the truth tellers. At prediction, new instances with unknown class labels can either belong to the target class (the class learned during training, i.e. truth tellers) or to a new class that was not available during training (in our case, the liars). This type of learning problem is known as one-class classification. Following this logic, whether a one-class classifier can classify liars satisfactorily even if the model is trained only using data from truth tellers was tested. This ML algorithm was trained using logistic regression on the data of the 20 original truth tellers and tested on the new group of 20 participants (10 liars and 10 truth tellers). The one-class algorithm correctly classified 85% of the instances; specifically, it correctly classified 70% of the truth tellers as the target and 100% of the liars as the outlier (classification metrics are reported in Table 16). When the test was run on a group of 30 liars and 10 truth tellers, results are 29/30 liars correctly classified and 7/10 truth tellers correctly classified. These results indicated that the classifier trained only on truth tellers can identify liars with high-level accuracy.

TABLE 16

| | | | | | | | | |
|---|---|---|---|---|---|---|---|---|
| | | | | | | F- | | |
| | | TP | FP | Pre- | Re- | Mea- | ROC | PRC |
| Classifier | Accuracy | Rate | Rate | cision | call | sure | Area | Area |

Test

| | | | | | | | | |
|---|---|---|---|---|---|---|---|---|
| One-class | 85% | 0.850 | 0.150 | 0.885 | 0.850 | 0.847 | 1.000 | 1.000 |
| classifier | | | | | | | | |

Online Experiment.

To further evaluate the model, a second experiment was conducted, with participants recruited via the Web. The procedure used in this experiment was the same as the one previously described and only minor adaptations for online administration. Participants were recruited through a mailing list of students and alumni. Participants were randomly assigned to the truth-teller or liar condition. Two hundred ninety-seven subjects started the experiment. Participants who did not satisfy the recruitment criteria were excluded from further analysis. In more detail those excluded were: participants who did not respond to all stimuli (n=55) or who completed the test using a smartphone or a tablet (n=31); participants who did not speak Italian as first language (n=3), to exclude the possibility that the response time was influenced by a poor knowledge of the language; participants who completed the experiment with the clear intention to sabotage it (n=1); participants who took the task more than one time (n=15); and participants for whom the system did not record keystroke up time (n=41). After filtering the participants using these criteria, 151 participants (86 liars and 65 truth tellers) were used for the final analysis. It should be noted that the dropout rate was around 50%. Given that the recruited subjects were from among trusted participants and that comparable online lie detection experiments have reported a dropout rate around 30%, this figure (50%) could look somewhat high. However, in this study the 24% of participants were excluded because of non-compliance of the technical instructions that were given in the recruiting email (they were instructed about avoiding to use smartphones or tablet or using the non-supported browser Explorer given that it was not recording the up-times). One may presume that people who lack of motivation do not focus on all the instruction details before clicking the test link, increasing the rate of participants to be excluded.

The final group of 151 participants consisted of 41 males and 110 females (average age=41 years, sd=14.1; average education=19 years, sd=3.4). Data from the new 151 online-recruited participants were used to evaluate the models built with the original sample of 40 participants. The features entered in the models were those reported in Table 13. Results from the four ML classifiers are reported in Table 17. As the table demonstrates, the classification performance averaged over the four classifiers was 89%.

TABLE 17

| | | | | | | | | |
|---|---|---|---|---|---|---|---|---|
| | | | | | | F- | | |
| | | TP | FP | Pre- | Re- | Mea- | ROC | PRC |
| Classifier | Accuracy | Rate | Rate | cision | call | sure | Area | Area |

Test on 151 online-recruited participants00\\

| | | | | | | | | |
|---|---|---|---|---|---|---|---|---|
| Logistic | 86.1% | 0.861 | 0.135 | 0.864 | 0.861 | 0.861 | 0.930 | 0.911 |
| SVM | 88.7% | 0.887 | 0.093 | 0.902 | 0.887 | 0.888 | 0.897 | 0.857 |
| (SMO) | | | | | | | | |
| LMT | 90.1% | 0.901 | 0.086 | 0.908 | 0.901 | 0.901 | 0.959 | 0.953 |
| Random | 90.7% | 0.907 | 0.078 | 0.916 | 0.907 | 0.908 | 0.980 | 0.977 |
| Forest | | | | | | | | |

A second model was evaluated using the alternative set of predictors mentioned above (errors, prompted-firstdigit, prompted-enter, time before enter key flight and di-graph down-time average). The model was built on the original sample of 40 participants and tested on the 151 online-recruited participants. Results for the test set are as follows: Random Forest=90%, Logistic=90.1%, SVM=90.1% and LMT=90.7%. Finally, running a 10-fold cross-validation on the 151 online-recruited participants (features: errors, prompted-firstdigit adjusted Gulpease, firstdigit-enter, writing time, time key before enter down) the accuracy of the four classifiers is in the range of 92-94%. These results confirm that the proposed technique can spot liars with high-level accuracy even when administered online.

### Discussion

To applicant's knowledge, no current techniques were able to accurately spot whether a subject's ID is true or false without any information about the respondent's true identity. As shown by the experimental results herein, methods, systems and apparatus in accordance with the present disclosure are able to classify whether an ID is true or faked when liars do not provide any personal information that is then included in the test itself at greater than 90% accuracy.

Input dynamics, such as mouse and keyboard dynamics provide a rich source of data, including reaction times but also initiation time, velocity, acceleration, and the mouse's trajectory.

In the first set of experiments reported above order a model that efficiently spots participants with faked identities was developed, which tested the responders with questions that were expected and that liars over-learned in a preliminary learning phase (name, surname, date of birth, and place of birth). Together with expected questions targeting the ID document information, a set of unexpected questions related to the expected questions was also presented. Consider, for example, the place of birth. Expected questions that would appear on the ID card would be “Were you born in Pisa?” (requiring a YES response) or “Were you born in New York?” (requiring a NO response). Corresponding unexpected questions would be: “Is Florence the capital of your region of birth?” (requiring a YES response, given that Pisa, the place of birth, is in Tuscany, whose capital is Florence) and “Is Venice the capital of your region of birth?” (requiring a NO response, given that Pisa, the claimed place of birth, is in Tuscany, whose capital is Florence and not Venice). Another unexpected question related to the date of birth (derived from the date) was about zodiac. Truthtellers are supposed to be able to retrieve the responses about their true zodiac more automatically than liars; therefore, their response is expected to be more rapid, with less errors, and characterized by a more direct mouse trajectory. In general, unexpected questions are supposed to be rapidly retrieved by truth-tellers while liars have to mentally “compute” the response from the original expected information.

Mouse dynamics analyzed using a ML model yielded a correct classification of liars and truth-tellers with more than 90% accuracy. This result was achieved by developing a set of classifiers with comparable performance in the accuracy range 90±95% (Random Forest, SVM, Logistics, and LTM). Another group was collected and tested (10 truth tellers and 10 liars) to validate the model's generalization. In this group, the accuracy was confirmed to be comparable to that of the group used for developing the classifiers (95%=19/20 participants correctly classified), showing that the high accuracy achieved in the model-building stage was not the result of overfitting.

An analysis to identify the most important predictor by mouse dynamics was conducted, which was total errors followed by the MD-time, the AUC, and the position of the mouse along the y-axis on the 29th time frame. Similarly, an analysis to identify predictors using keyboard dynamics was conducted. From a cognitive point of view, it is confirmed that unexpected questions may be used to uncover deception. The power of unexpected questions has been extensively examined in investigative interrogations. Here, we extend the findings and confirm that unexpected questions may be embedded into an identity verification test to permit the identification of deceptive subjects with high accuracy. Liars find it hard to respond to unexpected questions quickly and without errors. Their uncertainty is captured by input dynamics, as their motor behavior diverges from the ideal truth-teller trajectory.

It is interesting to note that our experimental design requires liars to respond truthfully to a number of questions. The analysis performed on such truthful responses indicates that liars are still detectable, even if with a lower accuracy, when they are not lying. Rosenfeld et al. showed that truth telling liars could be identified using P300, similarly to what we report here. It is important to note that liars are required to respond truthfully to all stimuli except to expected and unexpected questions, which, by contrast, require a lie. Therefore, they have to switch between lying and truth telling and this switch has a cost that reveals itself also when responding truthfully, as shown by Debey et al. This means that the liar mind-set reflects itself in the mouse dynamics and that lie detection could also be extended to responses to which they are not lying. It is as if being instructed to lie to some questions but not to others induces a greater cognitive load in liars, which is not only related to the deceptive responses but also to switching between responses that require a lie and responses that require the truth.

Embodiments in accordance with the present disclosure that utilize keystroke dynamics may be especially suited for online contexts (e.g. to verify the authenticity of information typed by the user during an online subscription). Moreover, this setting allows for the use of covert lie detection, a lie-detection procedure in which the respondent is unaware of being tested for lies.

Methods, procedures, system and apparatus in accordance with the present disclosure have a number of advantages over known systems. They can be used to implement covert lie detection. They may not require external instrumentation because a participant only sees “standard” input devices such as a computer with a keyboard and/or a mouse. The number of predictors is high, rendering the development of effective countermeasures to lie detection difficult.

Examples of prototypical deceptive and truthful keystroke patterns are reported in Table 18, which is useful for visualizing the difference between liars and truth tellers revealed by keystroke pattern analysis.

TABLE 18

| | Prototypical | Prototypical |
|---|---|---|
| Feature | truthteller | liar |
| Number of errors | 0/18 = 0.00 | 7/18 = 0.39 |
| Prompted-firstdigit adjusted GULPEASE | 1649 ms | 3508 ms |
| Firstdigit-enter | 3123 ms | 442 ms |
| Writing time | 281 ms | 442 ms |
| Time key before enter down | 462 ms | 739 ms |

Example Computing Devices and Associated Media. The embodiments disclosed herein may include the use of a special purpose or general-purpose computer or a server including various computer hardware or software modules, as discussed in greater detail below. A computer or a server may include a processor or multiple processors thus affording parallel computing capabilities, and computer storage media carrying instructions that, when executed by the processor and/or caused to be executed by the processor, perform any one or more of the methods disclosed herein. An external database system exemplified by Microsoft SQL Server or Oracle Database or, alternatively, a simplified database system designed specifically for the processes disclosed herein may be part of one of the embodiments of the present disclosure.

Embodiments within the scope of the present disclosure may also include computer storage media, which are physical media for carrying or having computer-executable instructions or data structures stored thereon. Such computer storage media can be any available physical media that can be accessed by a general purpose or special purpose computer provided this storage media can operate at adequate read/write speeds.

By way of example, and not limitation, such computer storage media can comprise hardware such as solid state disk (SSD), RAM, ROM, EEPROM, CD-ROM, flash memory, phase-change memory (“PCM”), or other optical disk storage, magnetic disk storage or other magnetic storage devices, or any other hardware storage devices which can be used to store program code in the form of computer-executable instructions or data structures, which can be accessed and executed by a general-purpose or special-purpose computer system or a server to implement the disclosed functionality of an embodiment in accordance with this disclosure. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which cause a general purpose computer, special purpose computer, or a server, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ can refer to software objects or routines that execute on the computing system. The different components, modules, engines, and services described herein may be implemented as objects or processes that execute on the computing system, for example, as separate threads. While the system and methods described herein can be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein. In terms of computing environments, embodiments of the invention can be performed in client-server environments, whether network or local environments, or in any other suitable environment. Suitable operating environments for at least some embodiments of the invention include network computing environments.

As noted previously herein, in practice it has been found that a digital keyboard on a mobile device may be used in the place of a physical keyboard with movement parameters measured on the interactions of a user with the displayed buttons. Similarly, swipe gestures on a mobile device touchscreen display may be tracked and analyzed in a comparable manner to mouse movements and “taps” made on such a display may be tracked and analyzed similar to mouse click. This allows the techniques and systems in accordance with the present disclosure to be expanded to mobile platforms. Thus, touchscreen computers including tablets and mobile phones may be used in methods and systems in accordance with the present disclosure.

It will be appreciated that while specific software packages for the capturing of input dynamics, such as MouseTracker for mouse dynamics, are identified, that such programs are illustrative and any software, hardware, or systems that may be used to enable an embodiment in accordance with the present disclosure to capture and analyze input dynamics as a subject responds to the questions may be used.

### REFERENCES

Each cited reference is incorporated by reference herein in its entirety.
UEFA. Will the real Eriberto stand up. 20 Sep. 2002. http://www.uefa.com/news/newsid=34451.html.
Donath J S. Identity and deception in the virtual community. In: Smith M A, Kollock P. editors. Communities in cyberspace. London & New York: Routledge Press; 1999. pp. 29±59.
Barber S. The direct link between identity theft and terrorism, and ways to stop it. The University of Texas at Austin. 7 Dec. 2015. https://news.utexas.edu/2015/12/07/the-direct-link-between-identitytheft-and-terrorism
Agenzia Giornalistica Italia (AGI). Bruxelles: kamikaze usò identità ex giocatore dell'Inter. 28 Mar. 2016. http://www.agi.it/estero/2016/03/28/news/bruxelles_kamikaze_uso_identita_ex_giocatore_dellinter-650281/
Benussi V. Die atmungssymptome der luÈge. Archiv fuÈ r die gesamte Psychologie. 1914; 31:244±273.
Rosenfeld J P, Greely H T. Deception, detection of, p300 event related potential (erp). In: Wiley Encyclopedia of Forensic Science. John Wiley & Sons, Ltd; 2009.
Vrij A, Fisher R, Mann S, Leal S. A cognitive load approach to lie detection. Investigative Psychology and Offender Profiling. 2008; 5:39±43.
Van Bockstaele B, Verschuere B, Moens T, Suchotzki K, Debey E, Spruyt A. Learning to lie: Effects of practice on the cognitive cost of lying. Frontiers in Psychology. 2012; 3:526. https://doi.org/10.3389/fpsyg.2012.00526 PMID: 23226137
Kleinberg B, Verschuere B. Memory detection 2.0: The first web-based memory detection test. PLoS One. 2015; 10(4):e0118715. https://doi.org/10.1371/journal.pone.0118715 PMID: 25874966
Sartori G, Agosta S, Zogmaister C, Ferrara S D, Castiello U. How to accurately detect autobiographical events. Psychological Science. 2008; 19(8):772±780. https://doi.org/10.1111/j.1467-9280.2008.02156. x PMID: 18816284
Verschuere B, Kleinberg B. Id-check: Online concealed information test reveals true identity. Journal of Forensic Science. 2016 January; 61 Suppl 1:S237±40. https://doi.org/10.1111/1556-4029.12960 PMID:26390033
Agosta S, Sartori G. The autobiographical IAT: A review. Frontiers in Psychology. 2013; 4:519. https://doi.org/10.3389/fpsyg.2013.00519 PMID: 23964261
Meixner J, Rosenfeld J P. A Mock Terrorism Application of the P300-Based Concealed Information Test. Psychophysiology. 2011; 48:149±154. https://doi.org/10.1111/j.1469-8986.2010.01050.x PMID:20579312
Dale R, Duran N D. The cognitive dynamics of negated sentence verification. Cognitive Science. 2011; 35(5):983±996. https://doi.org/10.1111/j.1551-6709.2010.01164.x PMID: 21463359
Freeman J B, Pauker K, Sanchez D T. A perceptual pathway to bias: Interracial exposure reduces abrupt shifts in real-time race perception that predict mixed-race bias. Psychological Science. 2016; 27:502±517. https://doi.org/10.1177/0956797615627418 PMID: 26976082
QueÂtard B, Quinton J C, Colomb M, Pezzulo G, Barca L, Izaute M, et al. Combined effects of expectations and visual uncertainty upon detection and identification of a target in the fog. Cognitive Processing. 2015; 16:343±348.
Abney D H, McBride D M, Conte A M, Vinson D W. Response dynamics in prospective memory. Psychonomic Bulletin & Review. 2015; 22(4):1020±1028.
Barca L, Pezzulo G. Unfolding visual lexical decision in time. PLoS One. 2012; 7(4):e35932. https://doi.org/10.1371/journal.pone.0035932 PMID: 22563419
Duran N D, Dale R, McNamara D S. The action dynamics of overcoming the truth. Psychonomic Bulletin & Review. 2010; 17(4):486±491.
Vrij A. A cognitive approach to lie detection in Deception detection: Current challenges and new approaches. Oxford, UK: John Wiley & Sons, Inc.; 2015.
Vrij A, Leal S, Granhag P A, Mann S, Fisher R P, Hillman J, et al. Outsmarting the Liars: The Benefit of Asking Unanticipated Questions. Law and Human Behavior. 2009; 33:159±166. https://doi.org/10.1007/s10979-008-9143-y PMID: 18523881
Warmelink L, Vrij A, Mann S, Leal S, Poletiek F H. The Effects of Unexpected Questions on Detecting Familiar and Unfamiliar Lies. Psychiatry, Psychology And Law. 2013; 20(1).
Hartwig M, Granhag P A, StrcËmwall L. Guilty and innocent suspects' strategies during interrogations. Psychology, Crime, & Law. 2007; 13:213±227.
Lancaster G L J, Vrij A, Hope L, Waller B. Sorting the liars from the truth tellers: The benefits of asking unanticipated questions on lie detection. Applied Cognitive Psychology. 2013; 27:107±114.
Freeman J B, Ambady N. Mousetracker: Software for studying real-time mental processing using a computer mouse-tracking method. Behavior Research Methods. 2010; 42:226±241. https://doi.org/10.3758/BRM.42.1.226 PMID: 20160302
Hall M A. Correlation-based feature subset selection for machine learning. Thesis, The University of Waikato. 1999. http://www.cs.waikato.ac.nz/mhall/thesis.pdf.
Hall M, Frank E, Holmes G, Pfahringer B, Reutemann P, Witten I H. The weka data mining software: An update. ACM SIGKDD Explorations Newsletter. 2009; 11(1):10±18.
Breiman L. Random forests. Machine Learning. 2001; 45(1):5±32.
le Cessie S, van Houwelingen J C. Ridge estimators in logistic regression. Applied Statistics. 1992; 41(1):191±201.
Platt J C. Fast training of support vector machines using sequential minimal optimization. In: Advances in Kernel Methods. MIT Press Cambridge; 1999.
Keerthi S S, Shevade S K, C B, Murthy K R K. Improvements to platt's SMO algorithm for SVM classifier design. Neural Computation. 2001; 13(3):637±649.
Landwehr N, Hall M, Frank E. Logistic model trees. Machine Learning. 2005; 95(1±2):161±205.

Gao Z K, Cai Q, Yang Y X, Dong N, Zhang SS. Visibility Graph from Adaptive Optimal Kernel Time-Frequency Representation for Classification of Epileptiform EEG. International Journal of Neural Systems. 2017; 27(4): 1750005. https://doi.org/10.1142/S0129065717500058 PMID: 27832712
Dwork C, Feldman V, Hardt M, Pitassi T, Reingold O, Roth A. The reusable holdout: Preserving validity in adaptive data analysis. Science. 2015; 349:636±638. https://doi.org/10.1126/science.aaa9375PMID: 26250683
Wang J, Lu W, Liu L, Li L, Xia C. Utility Evaluation Based on One-To-N Mapping in the Prisoner's Dilemma Game for Interdependent Networks. PLoS ONE. 2016; 11(12):e0167083. https://doi.org/10.1371/journal.pone.0167083 PMID: 27907024
Chen M, Wang L, Sun S, Wang J, Xia C. Evolution of cooperation in the spatial public goods game with adaptive reputation assortment. Physics Letters A. 2016; 380 (1):40±47.
Chen M, Wang L, Wang J, Sun S, Xia C. Impact of individual response strategy on the spatial public goods game within mobile agents. Applied Mathematics and Computation. 2015; 251:192±202
Rosenfeld J P, Ellwanger J W, Nolan K, Wu S, Bermann R G, Sweet J. P300 scalp amplitude distribution as an index of deception in a simulated cognitive deficit model. International Journal of Psychophysiology. 1999; 33(1):3±19. PMID: 10451015
Debey E, Baptist L B, de Houwer J, Verschuere B. Lie, truth, lie: the role of task switching in a deception context. Psychological research-psychologische forschung. 2015; 79(3):478±488.
National Consortium for the Study of Terrorism and Responses to Terrorism (START). Global Terrorism Database, http://www.start.umd.edu/gtd (2015).
FRONTLINE. Crossing boarders: how terrorists use fake pasports, visas and other identity documents, http://www.pbs.org/wgbh/pages/frontline/shows/trail/etc/fake.html (2014).
Agenzia Giornalistica Italia (AGI), http://www.agi.it/estero/2016/03/28/news/bruxelles_kamikaze_uso_identita_ex_giocatore_dellinter-650281/(2016).
Sabena, F., Dehghantanha, A. & Seddon, A. P. A review of vulnerabilities in identity management using biometrics. Second International Conference on Future Networks, Sanya, Hainan 42-49, https://doi.org/10.1109/ICFN.2010.79 (2010).
Douceur, J. R. The sybil attack in Peer-to-peer Systems 251-260 (Springer, 2002).
Conti, M., Poovendran, R. & Secchiero, M. Fakebook: Detecting fake profiles in on-line social networks. Proceedings of the 2012 International Conference on Advances in Social Networks Analysis and Mining (ASONAM 2012), IEEE Computer Society 1071-1078 (2012).
Monrose, F. & Rubin, A. Keystroke dynamics as a biometric for authentication. Future Generation Computer Systems 16, 351-359 (2000).
Karnana, M., Akilab, M. & Krishnarajc, N. Biometric personal authentication using keystroke dynamics: A review. Applied Soft Computing 11, 1565-1573 (2011).
Monaro, M., Gamberini, L. & Sartori, G. Identity verification using a kinematic memory detection technique. Advances in Neuroergonomics and Cognitive Engineering, 123-132 (2016).
Monaro, M., Fugazza, F. I., Gamberini, L. & Sartori G. How human-mouse interaction can accurately detect faked responses about identity in Symbiotic Interaction (ed. Gamberini, L., Spagnolli, A., Jacucci, G., Blankertz, B. & Freeman J.). Symbiotic 2016. Lecture Notes in Computer Science, vol 9961 (Springer, Cham), https://doi.org/10.1007/978-3-319-57753-1_10 (2017).
Monaro, M., Gamberini, L. & Sartori, G. The detection of faked identity using unexpected questions and mouse dynamics. PLoS ONE 12(5), e017785, https://doi.org/10.1371/journal.pone.0177851 (2017).
Lancaster, G. L. J., Vrij, A., Hope, L. & Waller, B. Sorting the liars from the truth tellers: The benefits of asking unanticipated questions on lie detection. Applied Cognitive Psychology 27, 107-114 (2013).
Sartori, G., Agosta, S., Zogmaister, C., Ferrara, S. D. & Castiello, U. How to accurately detect autobiographical events. Psychological Science 19(8), 772-80 (2008).
Suchotzki, K., Verschuere, B., Van Bockstaele, B., Ben-Shakhar, G. & Crombez, G. Lying takes time: A meta-analysis on reaction time measures of deception. Psychol Bull 143(4), 428-453 (2017).
Ahmad, N., Szymkowiak, A. & Campbell P. A. Keystroke dynamics in the pre-touchscreen era. Frontiers in Human Neuroscience, 7, article 835, https://doi.org/10.3389/fnhum.2013.00835 (2013).
Giot, R., El-Abed M. & Rosenberger, C. Greyc keystroke: a benchmark for keystroke dynamics biometric systems. IEEE International
Conference on Biometrics: Theory, Applications and Systems (BTAS 2009), https://doi.org/10.1109/BTAS.2009.5339051 (2009).
Grimes, G. M., Jenkins, J. L. & Valacich, J. S. Assessing credibility by monitoring changes in typing behavior: the keystrokes dynamics deception detection model. Hawaii International Conference on System Sciences, Deception Detection Symposium (2013).
Banerjee, R., Feng, S., Kang, J. S. & Choi Y. Keystroke patterns as prosody in digital writings: a case study with deceptive reviews and essays. Conference on Empirical Methods in Natural Language Processing (EMNLP) 1469-1473 (2014).
Derrick, D. C, Meservy, T. O., Jenkins, J. L., Burgoon, J. K. & Nunamaker J. F. Detecting deceptive chat-based communication using typing behavior and message cues. ACM Transactions on Management Information Systems 4, 2(9) (2013).
Agosta, S. & Sartori, G. The autobiographical IAT: A review. Frontiers in Psychology 4, 519, https://doi.org/10.3389/fpsyg.2013.00519 (2013).
Verschuere, B. & Kleinberg, B. Id-check: Online concealed information test reveals true identity. Journal of Forensic Science 61(Suppl1), S237 (2016).
Mameli, F. et al. Honesty in Neuroimaging Personality, Social Cognition, and Character (eds Absher, J. R. & Cloutier, J.) 305-322 (Elsevier Inc., 2016).
Warmelink, L. et al. Thermal imaging as a lie detection tool at airports. Law Hum Behav 35, 40 (2011).
Horvath, F. Detecting deception: The promise and the reality of voice stress analysis. Journal of Forensic Sciences 27(2), 340-351 (1982).
Mihalcea, R. & Strapparava, C. The lie detector: Explorations in the automatic recognition of deceptive language. Proc. of ACLIJCNLP 309-312 (2009).
Vrij, A. et al. Outsmarting the liars: the benefit of asking unexpected questions. Law and Human Behavior 33(2), 159-66 (2009).
R. https://www.r-project.org/(2016).
Hall, M. et al. The WEKA Data Mining Software: An update. ACM SIGKDD Explorations Newsletter 11(1), 10-18 (2009).
Lucisano, P. & Piemontese, M. E. GULPEASE: una formula per la predizione della difficoltà dei testi in lingua italiana. Scuola e città 3, 110-24 (1988).
Navarro, D. J. Learning statistics with R: A tutorial for psychology students and other beginners, Version 0.5. (School of Psychology, University of Adelaide, Adelaide, Australia, 2015).
Hall, M. Correlation-based feature subset selection for machine learning. The University of Waikato http://www.cs.waikato.ac.nz/mhall/thesis.pdf (1999).
Breiman, L. Random Forests. Machine Learning 45(1), 5-32 (2001).
Platt, J. C. Fast training of support vector machines using sequential minimal optimization in Advances in Kernel Methods (MIT Press Cambridge, 1999).
Keerthi, S. S., Shevade, S. K., Bhattacharyya, C. & Murthy, K. R. K. Improvements to Platt's SMO algorithm for SVM classifier design. Neural Computation 13(3), 637-649 (2011).
Landwehr, N., Hall, M. & Frank, E. Logistic Model Trees. Machine Learning 95(1-2), 161-205 (2005).
Liu, F. T., Ming Ting, K. & Zhou, Z. Isolation-Based Anomaly Detection. ACM Transactions on Knowledge Discovery from Data (TKDD) 6(1) (2012)
Hempstalk, K., Frank, E. & Witten, I. H. One-Class Classification by Combining Density and Class Probability Estimation. Proceedings of the 12th European Conference on Principles and Practice of Knowledge Discovery in Databases and 19th European
Conference on Machine Learning, ECMLPKDD2008, Berlin 505-519 (2008).

While this disclosure has been described using certain embodiments, it can be further modified while keeping within its spirit and scope. This application is therefore intended to cover any variations, uses, or adaptations of the disclosure using its general principles. Further, this application is intended to cover such departures from the present disclosure as come within known or customary practices in the art to which it pertains and which fall within the limits of the appended claims.

What is claimed is:

1. A computer-implemented method for assessing the credibility of a subject's purported identity, the method comprising:
presenting the subject with a number of written questions displayed on a computer screen, wherein the number of written questions include at least one unexpected question;
requiring the subject to respond to the written questions by interacting with a computer input device;
collecting information regarding the movements made by the subject in using the computer input device to respond to the written questions; and
analyzing, by the computer, the collected information regarding movements made by the subject to assess one or more characteristics of movements made by the subject to assess a veracity of the subject.

2. The method according to claim 1, wherein collecting information regarding the movements made by the subject in using the computer input device to respond to the written questions using the one or more sets of written test items relating to one or more issues of relevance comprises collecting information regarding the movements made by the subject while utilizing a mouse.

3. The method according to claim 1, wherein analyzing, by the computer, the collected information regarding movements made by the subject to assess one or more characteristics of movements made by the subject to assess a veracity of the subject comprises analyzing a trajectory of movement made in responding to a question in comparison to an ideal trajectory required for a response.

4. The method according to claim 1, wherein analyzing, by the computer, the collected information regarding movements made by the subject to assess one or more characteristics of movements made by the subject to assess a veracity of the subject comprises analyzing a movement parameter selected from the group comprising velocity, acceleration, changes in direction, initiation time and reaction time.

5. The method according to claim 1, wherein collecting information regarding the movements made by the subject in using the computer input device to respond to the written questions comprises collecting information regarding the movements made by the subject while utilizing a keyboard.

6. The method according to claim 1, wherein analyzing, by the computer, the collected information regarding movements made by the subject to assess one or more characteristics of movements made by the subject to assess a veracity of the subject comprises analyzing the time to the initiation of a response made to a question or the total time taken in responding to a question.

7. The method according to claim 1, wherein analyzing, by the computer, the collected information regarding movements made by the subject to assess one or more characteristics of movements made by the subject to assess a veracity of the subject comprises analyzing a number of errors made in responding to questions.

8. The method according to claim 1, wherein presenting the subject with a number of written questions displayed on a computer screen, wherein the number of written questions include at least one unexpected question comprises presenting the subject with a number of written questions displayed on a computer screen, wherein the number of written questions include control questions that require truthful responses from at both truth tellers and liars as well as at least one unexpected question.

9. The method according to claim 1, wherein analyzing, by the computer, the collected information regarding movements made by the subject to assess one or more characteristics of movements made by the subject to assess a veracity of the subject comprises analyzing or more characteristics of movements made by the subject in responding to a control question.

10. The method according to claim 1, presenting the subject with a number of written questions displayed on a computer screen, wherein the number of written questions include at least one unexpected question is conducted as part of a series of questions the majority of which are unrelated to identity verification.

11. A system for assessing veracity, comprising:
a computing device including one or more hardware processors;
a peripheral input device for interaction with a user of the system, the peripheral input device configured to gather data concerning movements made by the user while interacting with the peripheral input device, and the peripheral input device is configured for communication with the computing device;
a non-transitory storage medium having stored therein computer-executable instructions which, when executed by the one or more hardware processors:
present a subject with a number of questions, wherein the number of questions includes at least one unexpected question;
require the subject to respond to the number questions by interacting with peripheral input device;
collect the gathered information regarding the movements made by the subject in using the peripheral input device to respond to the number of questions; and
analyze the collected information regarding movements made by the subject to assess one or more characteristics of movements made by the subject to assess a veracity of the subject.

12. The system of claim 11, wherein the peripheral input device comprises a mouse and the system is operable to collect gathered information regarding the movements made by the subject in using the peripheral input device by collecting information regarding the movements made by the subject while utilizing a mouse.

13. The system of claim 11, wherein the system is operable to analyze the collected information regarding movements made by the subject to assess one or more characteristics of movements made by the subject to assess a veracity of the subject by analyzing a trajectory of movement made in responding to a question in comparison to an ideal trajectory required for a response.

14. The system of claim 11, wherein the system is operable to analyze the collected information regarding movements made by the subject to assess one or more characteristics of movements made by the subject to assess a veracity of the subject by analyzing a mouse movement parameter selected from the group comprising velocity, acceleration, changes in direction, initiation time and reaction time.

15. The system of claim 11, wherein the peripheral input device comprises a keyboard and the system is operable to collect gathered information regarding the movements made by the subject in using the peripheral input device by collecting information regarding the movements made by the subject while utilizing a keyboard.

16. The system of claim 11, wherein the system is operable to analyze the collected information regarding movements made by the subject to assess one or more characteristics of movements made by the subject to assess a veracity of the subject by analyzing the time to the initiation of a response made to a question or the total time taken in responding to a question.

17. The system of claim 11, wherein the system is operable to analyze the collected information regarding movements made by the subject to assess one or more characteristics of movements made by the subject to assess a veracity of the subject by analyzing a number of errors made in responding to questions.

18. The system of claim 11, wherein the system is operable to present a subject with a number of questions, wherein the number of questions includes at least one unexpected question by presenting the subject with a number of questions including control questions that require truthful responses from at both truth tellers and liars as well as at least one unexpected question.

19. The system of claim 18, wherein the system is operable to analyze the collected information regarding movements made by the subject to assess one or more characteristics of movements made by the subject to assess a veracity of the subject by analyzing or more characteristics of movements made by the subject in responding to a control question.

20. The system of claim 11, wherein the system is operable to present a subject with a number of questions comprising written questions displayed on a computer screen.
